(19) United States
(12) Patent Application Publication
(10) Pub. No.: US 2007/0271214 A1
(43) Pub. Date: Nov. 22, 2007

(54) Clinical trail support system using medical imaging information

(75) Inventors: Shigeo Sumino, Fuchu (JP); Tomohiro Yasuda, Kokubunji (JP); Yoshitaka Bito, Kokubunji (JP); Yoshiki Niwa, Hatoyama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/798,889

(22) Filed: May 17, 2007

(30) Foreign Application Priority Data
May 18, 2006 (JP) 2006-138933

(51) Int. Cl. G06F 17/30

(52) U.S. Cl. 707/1

(57) ABSTRACT

A clinical trial support system suitable for the investigation of an adverse event or the like. A clinical trial database stores: information about sponsors; information about trial sites; product information including the product names, classification, chemical structure, and pharmacokinetics of trial drugs; trial information including trial name, target disease, phase, and completed status; contract information including trial site name, contracted number of cases, and completed status; trial subject information including sex, birth of date, height, weight, and completed status; and visit information including visit date, inspection result, and medical imaging data. An information control unit distributes a search interface for the analysis of an adverse event to the trial sponsor and a retrieval result to the trial site.

### CLAIM OF PRIORITY

The present application claims priority from Japanese application JP 2006-138933 filed on May 18, 2006, the content of which is hereby incorporated by reference into this application.

### BACKGROUND OF THE INVENTION

1. Field of the Invention

The present invention relates to the management of inspection data concerning nonclinical studies, clinical studies, and clinical trials. Particularly, the invention relates to a clinical trial support system that can be suitably used for the investigation of the cause of a serious adverse event or the like during a nonclinical study, clinical study, or a clinical trial involving medical imaging information, such as MRI, CT, or PET information.

2. Background Art

As a result of the wide-spread use of medical imaging system for MRI, CT, and PET, as well as the advance in molecular imaging technology, there is now the possibility of utilizing such equipment for drug metabolism monitoring, which is considered to offer benefits for nonclinical studies, clinical studies, and clinical trials. In conventional clinical studies and clinical trials, inspection results for a trial subject acquired at a medical institution were sent to drug manufacturers in the form of a case report on paper or text data (eCRF: electrical case report form, or EDC: electrical data capturing) for each visit. Thus, the drug manufacturers only needed to handle data on paper or text data, of which the volume was relatively small. An example of the EDC system is disclosed in JP Patent Publication (Kokai) No. 2002-015061 A entitled “Clinical Trial Implementation Management System.” Meanwhile, the wide-spread use of medical imaging system and the user's demand for more advanced medical care have led to an increased use of medical images. This has resulted in increasing volumes of stored medical images, accompanied by the demand for medical image retrieval systems, such as “Similar Image Retrieval System” disclosed in JP Patent Publication (Kokai) No. 2004-5364 A.

### SUMMARY OF THE INVENTION

To utilize medical imaging system in clinical studies and clinical trials and handle medical imaging information, it is necessary to perform 2- or 3-dimensional image processing and handle large volumes of data. In the event of a side-effect such as an adverse event, it becomes necessary to search or refer to past data in an attempt to look for the cause. When such data consists of text data, a search could be easily conducted using conventional techniques. However, the search becomes more problematic when the data consists of 2- or 3-dimensional images or complex data structures. While the aforementioned JP Patent Publication (Kokai) No. 2002-015061 A describes the entry of clinical trial data in detail, it offers no mention about how a search can be conducted to look for the cause of an adverse event or the like, nor how medical images can be utilized.

Furthermore, since medical imaging information contains large volumes of data, handling of medical imaging information demands much from the user in terms of interpretation of the displayed retrieval results, which if consisted of text data could be readily viewed. While the aforementioned JP Patent Publication (Kokai) No. 2002-015061 A describes a system for searching a large number of medical images for images similar to a retrieval key image, it does not mention how such images can be presented if a large number of images have been extracted.

In view of the foregoing problems associated with the use of medical imaging information in clinical studies and clinical trials, it is an object of the invention to provide a clinical trial support system suitable for the investigation of the cause of an adverse event or the like.

A clinical trial support system using medical imaging information according to the invention comprises: a clinical trial database in which information about drugs, information about trials, information about trial subjects, and visit information about the visit date of a trial subject who made a visit, inspection results, medical images, and an adverse event are stored in association with one another; a retrieval condition entry means having a retrieval key entry area and a retrieval image key entry area for entering a condition for retrieval; a retrieval means for searching the clinical trial database so as to extract visit information corresponding to a retrieval key entered via the retrieval condition entry means and a medical image accompanying the visit information; means for detecting special and common features from a plurality of medical images extracted by the retrieval means; and a display means for displaying a retrieval result.

Since the various information generated in connection with a trial is stored in a hierarchical structure in accordance its dependency relationships, a search for the investigation of the cause of an adverse event or the like can be conducted efficiently. Because medical images obtained as retrieval results are processed and special and common features are detected from the results, and also related information about such features can be obtained, an analysis of the retrieval results by the user can be facilitated.

Since retrieval conditions can be entered both by means of a selection area or an entry area and by means of a medical image, a search for the investigation of the cause of an adverse event and the like can be performed efficiently. By displaying the medical imaging data according to each trial site and each trial subject, and displaying past information with reference to a visit during which a problem occurred, an analysis of the retrieval results by the user can be facilitated.

### BRIEF DESCRIPTION OF THE DRAWINGS

FIG. 1 is a block diagram showing the relationships of related institutions in a first embodiment of the invention.

FIG. 2 is a block diagram of a system configuration of sponsors A and B.

FIG. 3 is a block diagram of a system configuration of trial sites α, β, and γ.

FIG. 4 is a block diagram of a system configuration of a clinical trial center.

FIG. 5 is a block diagram showing the structure of an information control unit in detail.

FIG. 6 is a block diagram of the areas of tables stored in a clinical trial database.

FIG. 7 shows tables stored in a sponsor information storage area and a product information storage area.

FIG. 8 shows tables stored in a trial information storage area and a contract information storage area.

FIG. 9 shows tables stored in a trial site information storage area and a trial subject information storage area.

FIG. 10 shows tables stored in a visit information storage area, a medical imaging information storage area, and an image processing module information storage area.

FIG. 11 is a block diagram showing the dependency relationships of the information stored in the clinical trial database.

FIG. 12 shows an interface for allowing a sponsor to register sponsor information.

FIG. 13 shows an interface for allowing a sponsor to register product information.

FIG. 14 shows an interface for allowing a sponsor to register trial information.

FIG. 15 shows an interface for allowing a sponsor to register contract information.

FIG. 16 shows an interface for allowing a trial site to register trial site information.

FIG. 17 shows an interface for allowing a trial site to register trial subject information.

FIG. 18 shows an interface for allowing a trial site to register visit information and medical imaging information.

FIG. 19 shows an interface for allowing a sponsor and a trial site to enter a retrieval condition for a search.

FIG. 20 shows a retrieval key entry area that is entered by a sponsor and a trial site when conducting a search.

FIG. 21 shows a retrieval image key entry area that is entered by a sponsor and a trial site when conducting a search.

FIG. 22 shows an interface for displaying retrieval results obtained with the use of retrieval conditions entered by a sponsor and a trial site.

FIG. 23 shows a retrieval result image display area for displaying an image obtained with the use of retrieval conditions entered by a sponsor and a trial site.

FIG. 24 shows a diagram for the description of an operation event performed with respect to a clinical trial support center along a time axis.

FIG. 25 shows a flowchart of a procedure at the sponsor end in a clinical trial support system.

FIG. 26 shows a flowchart of a procedure at the trial site end in the clinical trial support system.

FIG. 27 shows a flowchart showing the procedure of a retrieval process in detail.

FIG. 28 shows a flowchart showing the procedure of a retrieval condition accepting process in detail.

FIG. 29 shows a flowchart showing the procedure of a retrieval results acquisition process in detail.

FIG. 30 shows a diagram for the description of an example of the use of a clinical trial system.

FIG. 31 shows a diagram for the description of another example of the use of the clinical trial system.

### DESCRIPTION OF THE PREFERRED EMBODIMENTS OF THE INVENTION

In the following, embodiments of the clinical trial support system of the invention are described in detail with reference to the drawings.

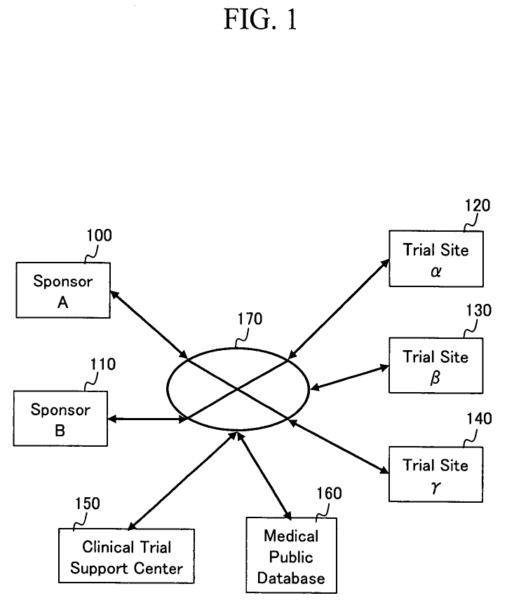

FIG. 1 is a block diagram showing the relationships among related institutions in a first embodiment of the invention. Numerals 100 and 110 designate sponsors A and B, respectively, which are the drug companies or the like that sponsor a nonclinical study, clinical study, or clinical trial using a clinical trial support center according to the invention. Numerals 120, 130, and 140 designate trial sites α, β, and γ, respectively, which are the medical facilities or the like that are entrusted with a nonclinical study, clinical study, or clinical trial by the sponsors A 100 and B 110. Numeral 150 designates the clinical trial support center that runs the clinical trial support system of the invention. Numeral 160 designates a medical public database that manages published information that the clinical trial support system refers to. Numeral 170 designates a communication network such as the Internet that the sponsors A 100 and B 110, and the trial sites α 120, β 130, and γ 140 use for accessing the clinical trial support center 150. It is noted that the numbers of the sponsors, the trial sites, and the medical public databases are not limited two, three, and one, respectively.

The clinical trial support system of the invention is installed at the clinical trial support center 150. It acquires information about trials from the sponsors A 100 and B 110 and trial subject information and inspection information about relevant trial subjects from the trial sites α 120, β 130, and γ 140, and stores such information in a hierarchical structure in accordance with its dependency relationships.

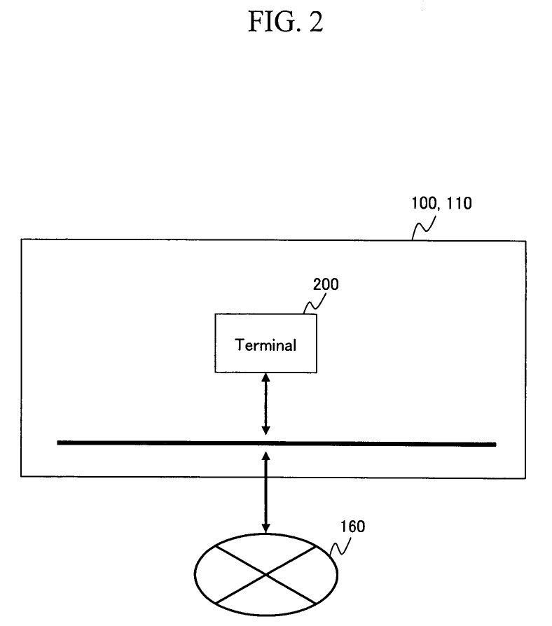

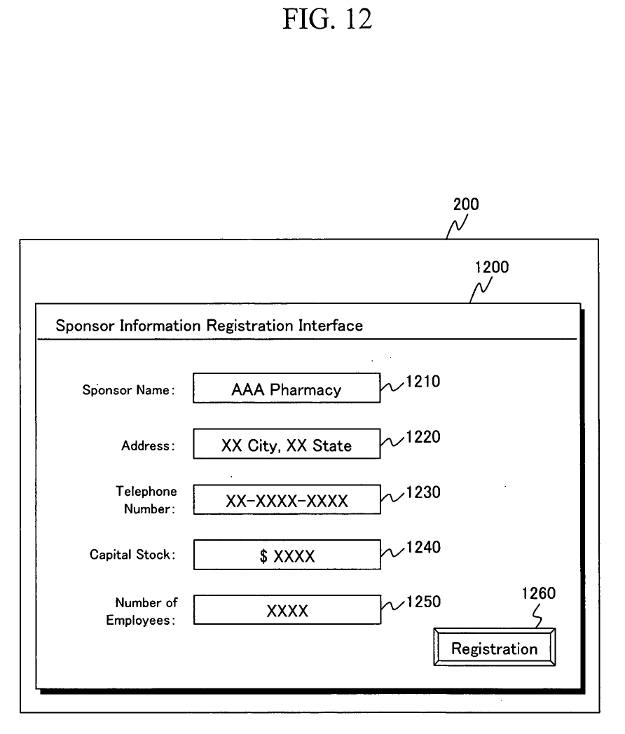

FIG. 2 is a block diagram showing a system configuration of the sponsors A and B. Numeral 200 designates a terminal that the sponsors A 100 and B 110 use for the registration of sponsor information, product information, trial information, and contract information, as well as for the input of retrieval conditions and the display of retrieval results, as will be described in detail with reference to FIGS. 12, 13, 14, 15, 19, and 22.

In this configuration, the sponsors A 100 and B 110, using the terminal 200, access the clinical trial support center 150 via the Internet 170, and register: product information each time development of a drug is initiated; trial information after each of a plurality of trials that are conducted for each product; and contract information concerning each trial site with which a contract is concluded regarding a trial. When it is necessary to refer to past data for analyzing information during or after a trial, the sponsors A 100 and B 110 can access the clinical trial support center 150 using the terminal 200, enter desired retrieval conditions to conduct a search, and refer to the retrieval results.

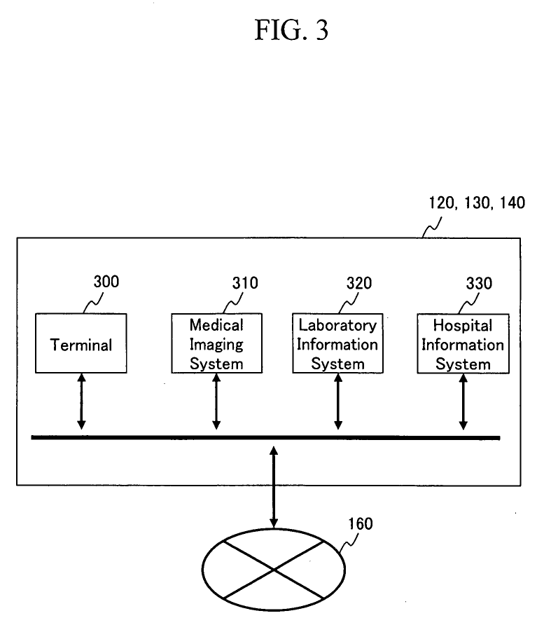

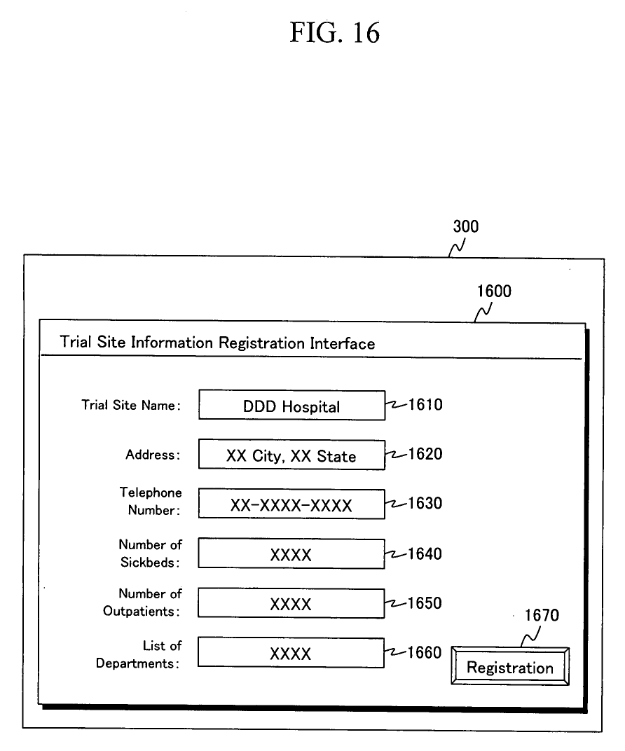

FIG. 3 is a block diagram of a system configuration of the trial sites α, β, and γ. Numeral 300 designates a terminal that the trial sites α 120, β 130, and γ 140 use for the registration of: trial site information; trial subject information; visit information; and medical imaging information, as well as for the entry of retrieval conditions and the display of retrieval results, as will be described in detail with reference to FIGS. 16, 17, 18, 19, and 22. Numerals 310 and 320 designate a medical imaging system, such as a CT or an MRI, and a laboratory information system, respectively, which are used for the inspection of a trial subject upon each visit. Numeral 330 designates a hospital information system that manages personal information about the trial subject and his or her medical care history and the like.

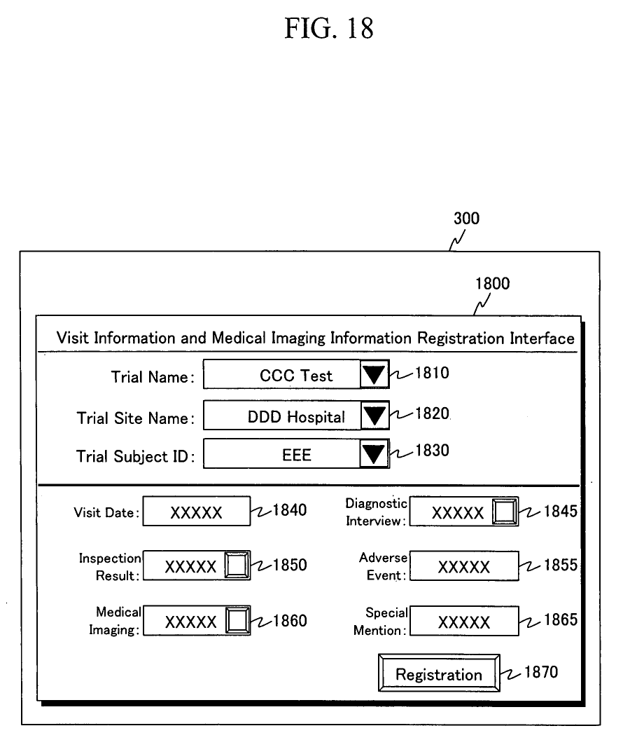

In this configuration, the trial sites α 120, β 130, and γ 140 access the clinical trial support center 150 via the Internet 170 using the terminal 300, and register trial subject information about each trial subject of a commissioned trial, and visit information and medical imaging information upon each visit of the trial subject. For the registration of visit information and medical imaging information, the trial sites α 120, β 130, and γ 140 acquires medical imaging information from the medical imaging system 310 and inspection information and the like from the laboratory information system 320 and the hospital information system 330, and registers such information using the information registration interface shown in FIG. 18. As in the case of the sponsors, when it is desired to refer to past data during or after a trial for the analysis of information, the trial sites α 120, β 130, and γ 140 can access the clinical trial support center 150 via the terminal 300 and conduct a search, and refer to retrieval results.

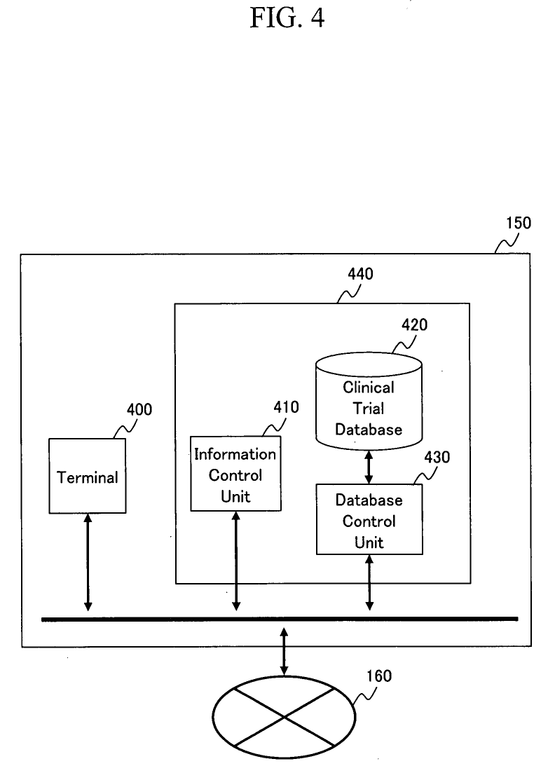

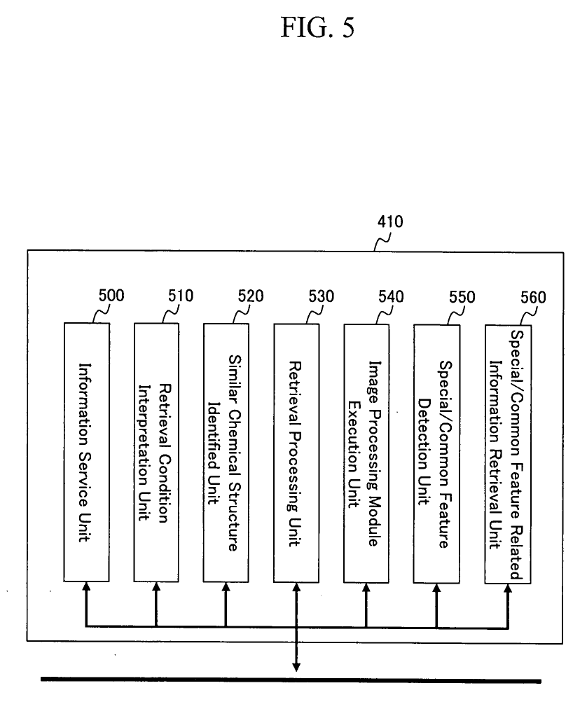

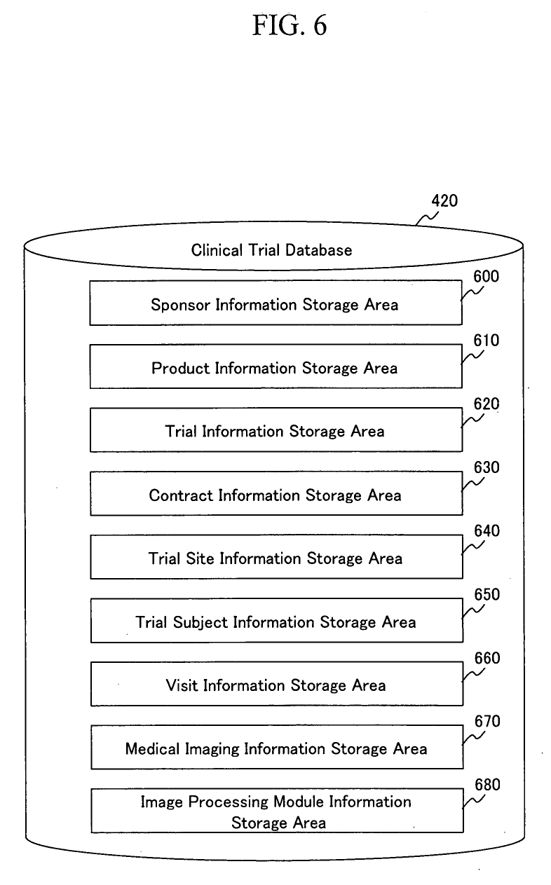

FIG. 4 is a block diagram of a system configuration of the clinical trial support center. Numeral 400 designates a terminal for the input and output of data in the system. Numeral 410 designates an information control unit by which the clinical trial support system is mainly controlled. Numeral 420 designates a clinical trial database for the management of data in the clinical trial support system. Numeral 430 designates a database control unit for accessing the clinical trial database 420. Numeral 440 designates the clinical trial support system of the invention. The information control unit 410 and the clinical trial database 420 will be described with reference to FIGS. 5 and 6 later.

The clinical trial system 440 of the invention is accessed by the sponsors A 100 and B 110 and the trial sites α 120, β 130, and γ 140 via the Internet 170. The clinical trial support system 440 processes such access in the information control unit 410; necessary information is exchanged with the clinical trial database 420 as needed via the database control unit 430. The clinical trial support system 440 processes, in the information control unit 410, overall information about a trial entered via the terminal 200 of the sponsors A 100 and B 110 and various information about trial subjects entered via the terminal 300 of the trial sites α 120, β 130, and γ 140. The processed data is stored in the clinical trial support database 420 in a hierarchical structure in accordance with in accordance with its dependency relationships.

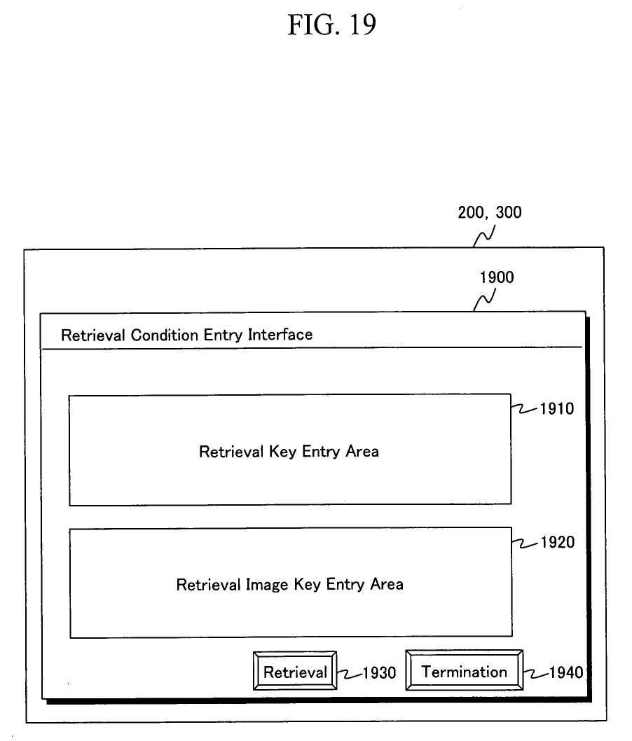

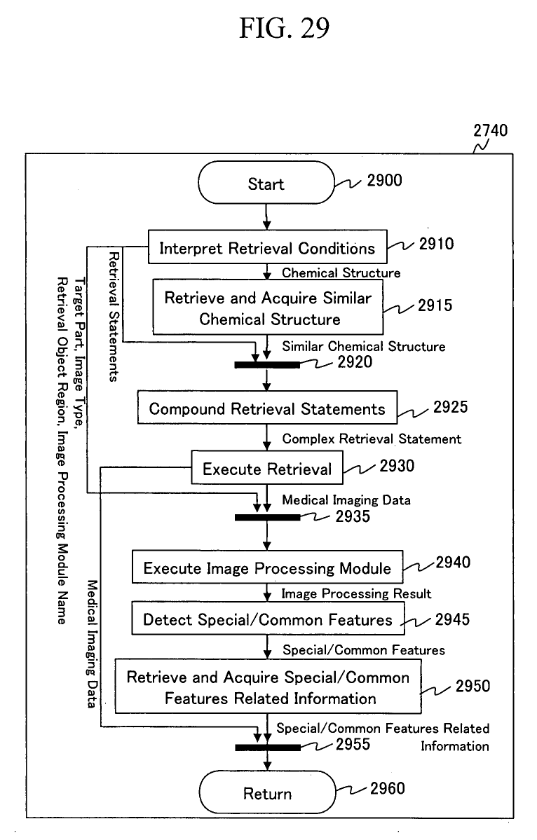

FIG. 5 is a block diagram showing the configuration of the information control unit in detail. Numeral 500 designates an information service unit for distributing various interfaces, of which the details will be described later with reference to FIGS. 12 to 23, to the terminal 200 of the sponsors A 100 and B 110 and to the terminal 300 of the trial sites α 120, β 130, and γ 140. Numeral 510 designates a retrieval condition interpretation unit that interprets a retrieval condition entered as shown in FIG. 19 and sends relevant information to the subsequent process step. Numeral 520 designates a similar chemical structure identified unit that searches the clinical trial database 420 or the medical public database 160 for a structural formula similar to a chemical structure entered as shown in FIG. 19 and that identifies such formula. Numeral 530 designates a retrieval processing unit for acquiring relevant information from the clinical trial database 420 via the database control unit 430 based on the interpretation of the retrieval condition obtained from the retrieval condition interpretation unit 510 and the similar chemical formula obtained from the similar chemical structure identified unit 520. Numeral 540 designates an image processing module execution unit for executing an image processing module for processing medical imaging information obtained from the retrieval processing unit 530. Numeral 550 designates a special/common feature detection unit for extracting special and common features from the processed medical imaging information obtained from the image processing module execution unit 540. Numeral 560 designates a special/common feature related information retrieval unit for searching the clinical trial database 420 or the medical public database 160 for the related information about the special and common features obtained from the special/common feature detection unit 550. The process performed by each unit and how relevant information is transmitted will be described with reference to FIG. 29 in detail.

In this configuration, the clinical trial support system 440 can conduct a search based not only on a chemical structure entered as a retrieval condition but also structures similar to such chemical structure. Thus, the system can acquire information that could have been overlooked by the user. Furthermore, the system not only processes the medical imaging information acquired as retrieval results, but it can also process the relevant medical images to detect special and common features therein and acquire related information about such features. Since the system displays not just medical imaging information but also special and common features related information, the system facilitates the analysis of retrieval results by the user.

FIG. 6 is a block diagram of the areas in a table stored in the clinical trial database. Numeral 600 designates a sponsor information storage area for the storage of information about the sponsors A 100 and B 110. Numeral 610 designates a product information storage area for the storage of information about particular drugs being developed by the sponsors A 100 and B 110. Numeral 620 designates a trial information storage area for the storage of information about nonclinical studies, clinical studies, or clinical trials that the sponsors A 100 and B 110 commissioned to the trial sites α 120, β 130, and γ 140. Numeral 630 designates a contract information storage area for the storage of contract conditions regarding the nonclinical studies, clinical studies, or clinical trials. Numeral 640 designates a trial site information storage area for the storage of information about the trial sites α 120, β 130, and γ 140. Numeral 650 designates a trial subject information storage area for the storage of information about the trial subjects of the nonclinical studies, clinical studies, or clinical trials. Numeral 660 designates a visit information storage area for the storage of information about inspections or the like conducted upon each visit of the trial subject to the trial sites α 120, β 130, and γ 140. Numeral 670 designates a medical imaging information storage area for the storage of medical images acquired by an inspection upon visit. Numeral 680 designates an image processing module information storage area for the storage of a program for processing medical images and its specification and the like.

The information stored in the trial subject information storage area 650 is not limited to information about humans. The term “nonclinical study” refers to a study for confirming the effectiveness or safety of a drug on animals; the term “clinical trial” refers to a trial for confirming the effectiveness or safety of a drug on humans; and the term “clinical trial” refers to a trial with a therapeutic purpose conducted for the development of a new drug. Although the three have different targets and purposes, their procedures are substantially identical. Thus, in the present specification, they are hereafter referred to collectively as trials.

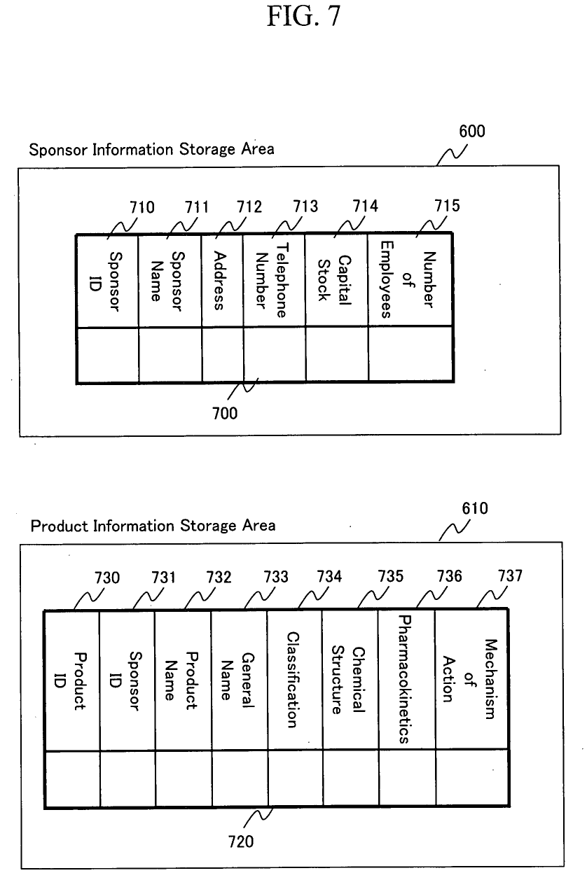

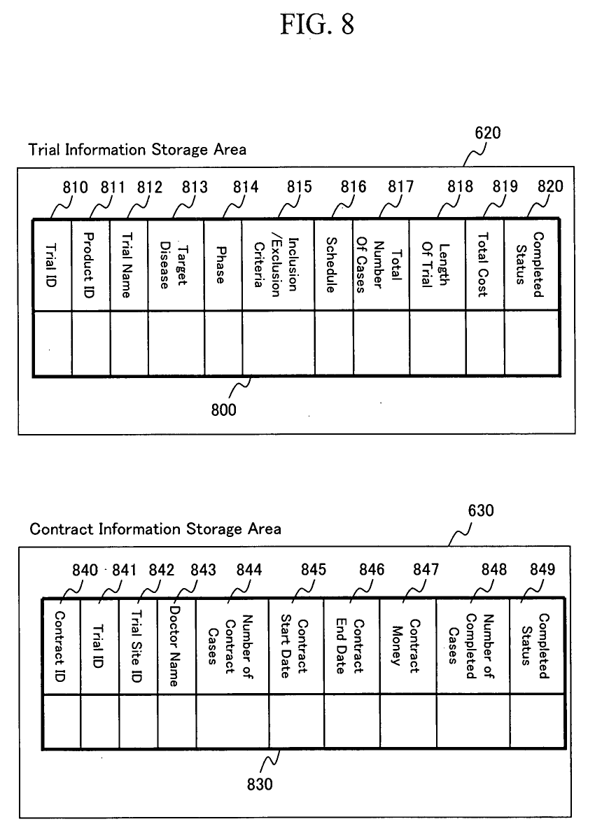

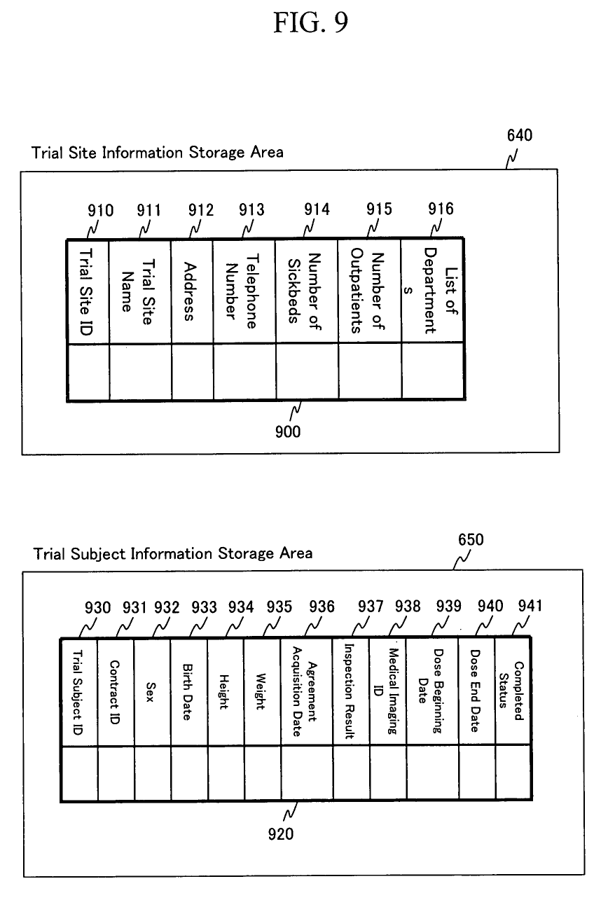

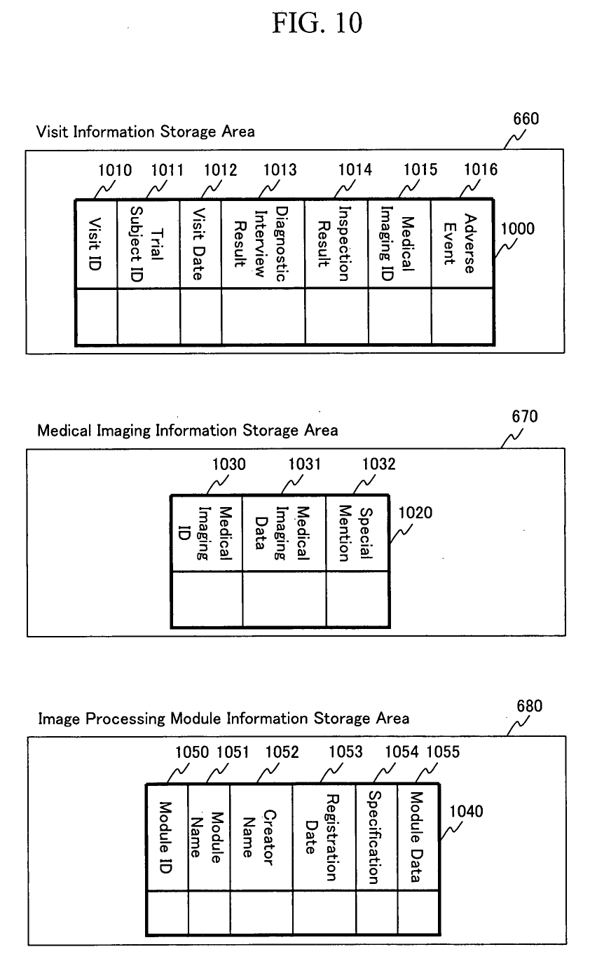

The sponsor information storage area 600 and the product information storage area 610 will be described with reference to FIG. 7. The trial information storage area 620 and the contract information storage area 630 will be described with reference to FIG. 8. The trial site information storage area 640 and the trial subject information storage area 650 will be described with reference to FIG. 9. The visit information storage area 660, the medical imaging information storage area 670, and the image processing module information storage area 680 will be described with reference to FIG. 10.

In this configuration, the clinical trial support system 440 manages the various information acquired from the sponsors A 100 and B 110 and the trial sites α 120, β 130, and γ 140 in a hierarchical structure in accordance with its dependency relationships, and distributes such information as needed using the information control unit 410.

FIG. 7 shows tables stored in the sponsor information storage area and the product information storage area. Numeral 700 designates a sponsor information table stored in the sponsor information storage area 600. Numeral 710 designates a sponsor ID area for managing a primary key to the sponsor information table 700. Numeral 711 designates a sponsor name area for managing the sponsor name. Numeral 712 designates an address area for managing the address of the sponsor. Numeral 713 designates a telephone number area for managing the telephone number of the sponsor. Numeral 714 designates a capital stock area for managing the value of the sponsor's capital stock. Numeral 715 designates a number of employees area for managing the number of employees of the sponsor. Numeral 720 designates a product information table stored in the product information storage area 610. Numeral 730 designates a product ID area for managing a primary key to the product information table 720. Numeral 731 designates a sponsor ID area for managing a foreign key to the sponsor information table 700. Numeral 732 designates a product name area for managing the product name of a drug that is the subject of trial. Numeral 733 designates a general name area for managing the general name of the drug. Numeral 734 designates a classification area for managing the classification of the drug. Numeral 735 designates a chemical structure area for managing the chemical structure of the drug. Numeral 736 designates a pharmacokinetics area for managing pharmacokinetics information about the drug. Numeral 737 designates a mechanism of action area for managing information about the mechanism by which the drug acts on a living organism.

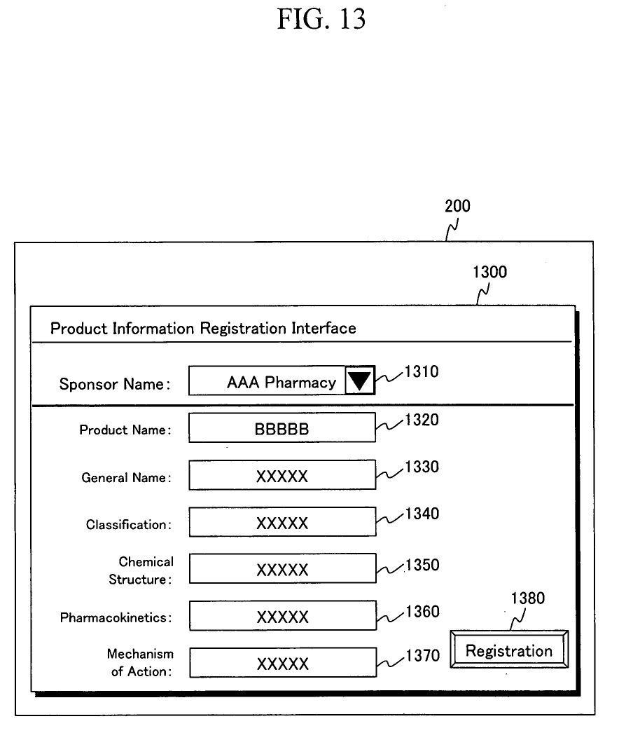

The interface for the registration of information in the sponsor information table 700 will be described with reference to FIG. 12. The interface for the registration of information in the product information table 720 will be described with reference to FIG. 13.

In this configuration, the clinical trial support system 440 manages the information about the sponsors A 100 and B 110 and the information about the products developed by the sponsors in a hierarchical structure in consideration of its dependency relationships.

FIG. 8 shows tables stored in the trial information storage area and the contract information storage area. Numeral 800 designates a trial information table stored in the trial information storage area 620. Numeral 810 designates a trial ID area for managing a primary key to the trial information table 800. Numeral 811 designates a product ID area for managing a foreign key to the product information table 720. Numeral 812 designates a name area for managing the name of the trial. Numeral 813 designates a target disease area for managing the name of the target disease of the trial. Numeral 814 designates a phase area for managing information about the phase of the trial. Numeral 815 designates an inclusion/exclusion criteria area for managing information about a standard for the inclusion and exclusion of a trial. Numeral 816 designates a schedule area for managing dose schedule information regarding the trial. Numeral 817 designates a total number of cases area for managing the total number of cases in the trial. Numeral 818 designates a length of trial area for managing information about the period of the trial. Numeral 819 designates a total cost area for managing the amount of total cost required by the trial. Numeral 820 designates a completed status area for managing the status of the trial to make sure if the trial has been completed according to plan. Numeral 830 designates a contract information table stored in the contract information storage area 630. Numeral 840 designates a contract ID area for managing a primary key to the contract information table 830. Numeral 841 designates a trial ID area for managing a foreign key to the trial information table 800. Numeral 842 designates a trial site ID area for managing a foreign key to the trial site information table 900. Numeral 843 designates a doctor name area for the name of the doctor who is in charge of the trial at the trial site indicated by a trial site ID area 842. Numeral 844 designates the number of contract cases area for managing the number of cases with regard to which a contract has been concluded at the trial site. Numerals 845 and 846 designate a contract start date area and a contract end date area, respectively, for managing the dates of start and end of contract at the trial site. Numeral 847 designates a contract money area for managing the amount of the contract with the trial site. Numeral 848 designates a number of completed cases area for managing the number of cases that the trial site handled. Numeral 849 designates a completed status area for managing the status of the contract to make sure if the trial site has completed the contract according to plan.

The phase herein refers to each step of a trial. There are four phases from I to IV, which are implemented in sequential order. Phase I concerns a trial on a small number of healthy people; Phase II concerns a trial on a small number of sick people; Phase III concerns a trial on a large number of sick people; and Phase IV concerns a trial on a large number of people after the sales of a drug (http://www.vob.jp/chiken1.html). Since the clinical trial support system of the invention is also adapted to nonclinical studies, the system includes the step of nonclinical study as a phase in addition to Phases I to IV.

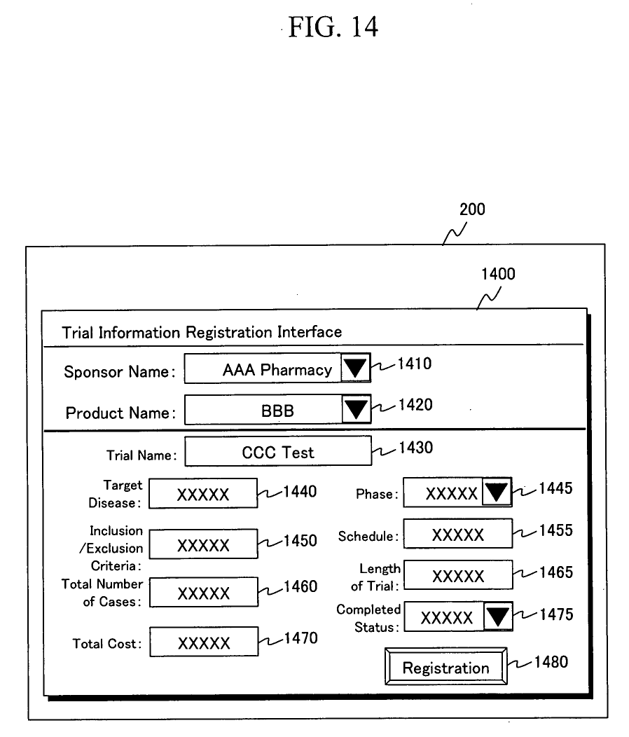

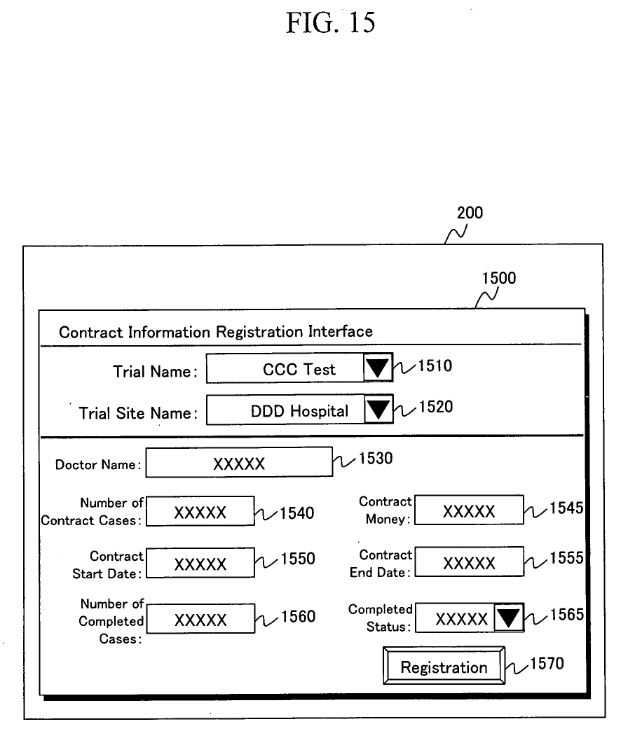

The interface for the registration of information in the trial information table 800 will be described with reference to FIG. 14; the interface for the registration of information in the contract information table 830 will be described with reference to FIG. 15.

In this configuration, the clinical trial support system 440 manages the information about the trials commissioned by the sponsors A 100 and B 110 and the contract information regarding the trials in a hierarchical structure in consideration of its dependency relationships.

FIG. 9 shows tables stored in the trial site information storage area and the trial subject information storage area. Numeral 900 designates a trial site information table stored in the trial site information storage area 640. Numeral 910 designates a trial site ID area for managing a primary key to the trial site information table 900. Numeral 911 designates a name area for managing the name of a trial site. Numeral 912 designates an address area for managing the address of the trial site. Numeral 913 designates a telephone number area for managing the telephone number of the trial site. Numeral 914 designates a number of sickbeds area for managing the number of sickbeds at the trial site. Numeral 915 designates a number of outpatients area for managing the number of outpatients at the trial site. Numeral 916 designates a list of departments area for managing a list of the names of departments at the trial site in which a trial can be conducted. Numeral 920 designates a trial subject information table stored in the trial subject information storage area 650. Numeral 930 designates a trial subject ID area for managing a primary key to the trial subject information table 920. Numeral 931 designates a contract ID area for managing a foreign key to the contract information table 830. Numerals 932, 933, 934, and 935 designate a sex area, a birth of date area, a height area, and a weight area, respectively, for managing information about the sex, birth of date, height, and weight of the trial subject. Numeral 936 designates an agreement acquisition date area for managing the date of acquisition of an agreement from the trial subject. Numerals 937 and 938 designate an inspection result area and a medical imaging ID area, respectively, for managing the results of an inspection conducted prior to the administration of a trial drug to the trial subject and the medical imaging information then acquired. Numerals 939 and 940 designate a dose beginning date area and a dose end date area, respectively, for managing the date of start and end of dose of a trial drug to the trial subject. Numeral 941 designates a completed status area for managing the status of dose to make sure if the trial subject has completed the dose of a trial drug according to plan.

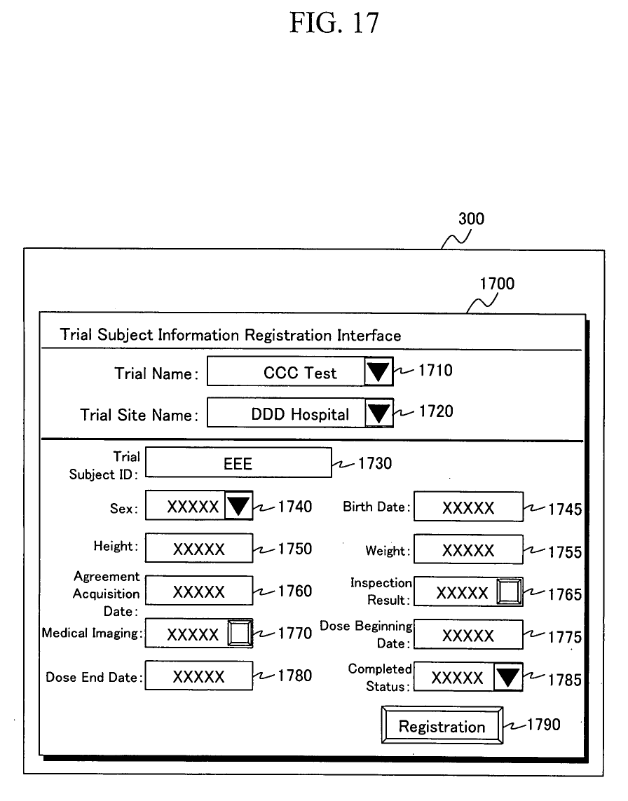

The interface for the registration of information in the trial site information table 900 will be described with reference to FIG. 16. The interface for the registration of information in the trial subject information table 920 will be described with reference to FIG. 17.

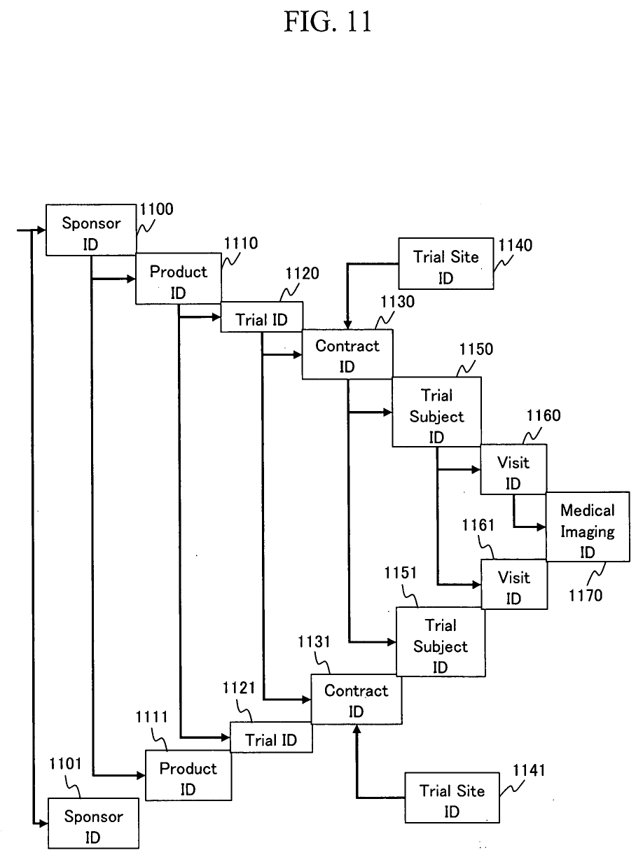

In this configuration, the clinical trial support system 440 manages the information about the trial sites α 120, β 130, and γ 140 and the information about the trial subject in a hierarchical structure in consideration of their dependency relationships. While there is no dependency relationship among the information in the example of FIG. 8, dependency arises via the contract information table 830. The dependency of such information will be described with reference to FIG. 11 in detail.

FIG. 10 shows tables stored in the visit information storage area, the medical imaging information storage area, and the image processing module information storage area. Numeral 1000 designates a visit information table stored in the visit information storage area 660. Numeral 1010 designates a visit ID area for managing a primary key to the visit information table 1000. Numeral 1011 designates a trial subject ID area for managing a foreign key to the trial subject information table 920. Numeral 1012 designates a visit date area for managing the visit date of a trial subject indicated by the trial subject ID area 1011. Numeral 1013 designates a diagnostic interview result area for managing information acquired from the trial subject on the visit date through a diagnostic interview. Numeral 1014 designates an inspection result area for managing the result of inspection on the visit date. Numeral 1015 designates a medical imaging ID area for managing medical imaging information in the inspection result. Numeral 1016 designates an adverse event area for managing information about an adverse event, such as a side effect, acquired on the visit date. Numeral 1020 designates a medical imaging information table stored in the medical imaging information storage area 670. Numeral 1030 designates a medical imaging ID area for managing a primary key to the medical imaging information table 1020. Numeral 1031 designates a medical imaging data area for managing the medical imaging information. Numeral 1032 designates a special mention area for managing a special mention about the medical imaging information. Numeral 1040 designates an image processing module information table stored in the image processing module information storage area 680. Numeral 1050 designates a module ID area for managing a primary key to the image processing module information table 1040. Numeral 1051 designates a name area for managing the name of an image processing module. Numeral 1052 designates a creator name area for managing the name of the creator of the image processing module. Numeral 1053 designates a registration date area for managing the date of registration of the image processing module. Numeral 1054 designates a specification area for managing the specification of the image processing module. Numeral 1055 designates a module data area for managing program data of the image processing module.

The interface for the registration of information in the visit information table 1000 and the medical imaging information table 1020 will be described with reference to FIG. 18. In this configuration, the clinical trial support system 440 manages the information about the visit of the trial subject and the medical imaging information obtained during such visit in a hierarchical structure in consideration of their dependency relationships.

FIG. 11 is a block diagram showing the dependency relationships of the information stored in the clinical trial database. Numerals 1100 and 1101 designates sponsor IDs each indicating a certain tuple of the sponsor information table 700. Numerals 1110 and 1111 designate product IDs each indicating a certain tuple of the product information table 720. Numerals 1120 and 1121 designate trial IDs each indicating a certain tuple of the trial information table 800. Numerals 1130 and 1131 designate contract IDs each indicating a certain tuple of the contract information table 830. Numerals 1140 and 1141 designate trial site IDs each indicating a certain tuple of the trial site information table 900. Numerals 1150 and 1151 designate trial subject IDs each indicating a certain tuple of the trial subject information table 920. Numerals 1160 and 1161 designate visit IDs each indicating a certain tuple of the visit information table 1000. Numeral 1170 designates a medical imaging ID indicating a certain tuple of the medical imaging information table 1020.

The number of the sponsor IDs, product IDs, trial IDs, contract IDs, trial site IDs, trial subject IDs, and visit IDs is not limited to two; likewise, the number of the medical imaging ID is not limited to one. Since a sponsor develops a plurality of products, there is a plurality of product IDs for any single sponsor ID. Similarly, since a plurality of trials are conducted for a product with one component, a plurality of trial IDs belong to any single product ID. There is a similar plural-singular relationship between trial ID and contract ID, contract ID and trial subject ID, trial subject ID and visit ID, and visit ID and medical imaging ID, with corresponding dependency relationships. In this configuration, the clinical trial support system 440 manages the information tables shown in FIGS. 7 to 10 in a hierarchical structure in consideration of such dependency relationships.

Thus, in accordance with the invention, information is centrally managed at the clinical trial support center 150, where the information is stored in a hierarchical structure in accordance with its dependency relationships, so that a search for the purpose of investigating the cause of an adverse event or the like can be conducted efficiently.

FIG. 12 shows an interface for the registration of sponsor information by the sponsor. Numeral 1200 designates a sponsor information registration interface for use in registering information in the sponsor information table 700. Numeral 1210 designates a sponsor name entry area for the entry of the sponsor's name in the sponsor name area 711. Numeral 1220 designates an address entry area for the entry of the sponsor's address in the address area 712. Numeral 1230 designates a telephone number entry area for the entry of the sponsor's telephone number in the telephone number area 713. Numeral 1240 designates a capital stock entry area for the entry of the amount of capital stock of the sponsor in the capital stock area 714. Numeral 1250 designates an employee entry area for the entry of the number of employees of the sponsor in the number of employee area 715. Numeral 1260 designates a registration button for the registration of the above information in the clinical trial database 420.

When the sponsors A 100 and B 110 use the clinical trial system 440 for the first time, it is necessary for them to enter information about themselves using the above interface and then depress the registration button 1260. After the sponsor information is registered in the clinical trial database 420 by the information service unit 500 in accordance with the above operation, the sponsors A 100 and B 110 can register product information and the like.

FIG. 13 shows an interface for the registration of product information by the sponsor. Numeral 1300 designates a product information registration interface for the registration of information in the product information table 720. Numeral 1310 designates a sponsor name selection area for the selection of a sponsor from the information registered in the sponsor information table 700. Numeral 1320 designates a product name entry area for the entry of a product name in the product name area 732. Numeral 1330 designates a general name entry area for the entry of a general name of the product in the general name area 733. Numeral 1340 designates a classification entry area for the entry of the classification of the product in the classification area 734. Numeral 1350 designates a chemical structure entry area for the entry of the chemical structure of the product in the chemical structure area 735. Numeral 1360 designates a pharmacokinetics entry area for the entry of information about the pharmacokinetics of the product in the pharmacokinetics area 736. Numeral 1370 designate a mechanism of action entry area for the entry of information about the mechanism of action of the product in the mechanism of action area 737. Numeral 1380 designate a registration button for the registration of the above information in the clinical trial database 420.

When the sponsor A 100 and B 110 that have their sponsor information registered wish to develop new products, they need to enter product information using the above interface and then depress the registration button 1380. After the information service unit 500 registers the product information in the clinical trial database 420 in accordance with the above operation, the sponsors A 100 and B 110 can register trial information and the like.

FIG. 14 shows an interface for the registration of trial information by the sponsor. Numeral 1400 designates a trial information registration interface for the registration of information in the trial information table 800. Numeral 1410 designates a sponsor name selection area for the selection of sponsor from the information registered in the sponsor information table 700. Numeral 1420 designates a product name selection area for the selection of a product name from the information registered in the product information table 720 that is related to the sponsor selected in the sponsor name selection area 1410. Numeral 1430 designates a trial name entry area for the entry of the name of the trial in the name area 812. Numeral 1440 designates a target disease entry area for the entry of a target disease name of the trial in the target disease area 813. Numeral 1445 designates a phase selection area for the selection of a phase of the trial from Non-clinical, Phase I, Phase II, Phase III, and Phase IV and for the entry of the phase in the phase area 814. Numeral 1450 designates an inclusion/exclusion criteria entry area for the entry of information about inclusion and exclusion standards in the inclusion/exclusion criteria 815. Numeral 1455 designates a schedule entry area for the entry of a dose schedule of the trial in the schedule area 816. Numeral 1460 designates a total number of cases entry area for the entry of the total number of cases in the trial in the total number of cases area 817. Numeral 1465 designates a length of trial entry area for the entry of a planned execution period for the entire trial in the length of trial 818. Numeral 1470 designates a total cost entry area for the entry of the amount of total cost of the trial in the total cost area 819. Numeral 1475 designates a completed status selection area for the selection of a completed status of the entire trial from completed, interrupted, and terminated and for the entry of a selected status in the completed status area 820. Numeral 1480 designates a registration button for the registration of the above information in the clinical trial database 420.

When the sponsors A 100 and B 110 that have their product information registered wish to conduct new trials, they need to enter trial information using the above interface and then depress the registration button 1480. After the information service unit 500 registers the trial information in the clinical trial database 420 in accordance with the above operation, the sponsors A 100 and B 110 can register contract information and the like.

FIG. 15 shows an interface for the registration of contract information by the sponsor. Numeral 1500 designates a contract information registration interface for the registration of information in the contract information table 830. Numeral 1510 designates a trial name selection area for the selection of a trial name from the information registered in the trial information table 800. Numeral 1520 designates a trial site sponsor name selection area for the selection of the name of a trial site from the information registered in the information table 900. Numeral 1530 designates a doctor name entry area for the entry of the name of a doctor in charge attached to the trial site in the doctor name area 843. Numeral 1540 designates a contracted number of cases entry area for the entry of the number of cases for which the trial site has concluded a contract in the contract number of cases area 844. Numeral 1545 designates a contract money entry area for the entry of the amount of a contract concluded by the trial site in the contract money entry area 847. Numerals 1550 and 1555 designate a contract start date entry area and a contract end date entry area, respectively, for the entry of a start date and an end date, respectively, of a trial for which the trial site has concluded a contract, in the contract start date area 845 and the contract end date area 846, respectively. Numeral 1560 designates a number of completed cases entry area for the entry of the number of cases actually handled at the trial site in the number of completed cases area 848. Numeral 1565 designates a completed status selection area for the selection of the status at the end of a contract at the trial site from completed, interrupted, and terminated, and for the entry of a selected status in the completed status area 849. Numeral 1570 designates a registration button for the registration of the above information in the clinical trial database 420.

When the sponsors A 100 and B 110 that have their trial information registered wish to register new information about a trial site, they need to enter contract information using the above interface and then depress the registration button 1570. After the information service unit 500 registers the contract information in the clinical trial database 420 in accordance with the relevant operation, trial sites α120, β130, and γ140 can register trial subject information or the like.

FIG. 16 shows an interface for the registration of trial site information by the trial sites. Numeral 1600 designates a trial site information registration interface for the registration of information in the trial site information table 900. Numeral 1610 designates a trial site name entry area for the registration of the name of the trial site in the trial site name area 911. Numeral 1620 designates an address entry area for the registration of the address of the trial site in the address area 912. Numeral 1630 designates a telephone number entry area for the registration of a telephone number of the trial site in the telephone number area 913. Numeral 1640 designates a number of sickbeds entry area for the registration of the number of sickbeds at the trial site in the number of sickbeds area 914. Numeral 1650 designates a number of outpatients entry area for the entry of an average number of outpatients per day at the trial site in the number of outpatients area 915. Numeral 1660 designates a list of departments entry area for the entry of a list of departments at the trial site where a trial can be conducted in the list of departments area 916. Numeral 1670 designates a registration button for the registration of the above information in the clinical trial database 420.

When the trial sites α120, β130, and γ140 use the clinical trial system 440 for the first time, they need to enter information about themselves using the above interface and then depress the registration button 1670. After the information service unit 500 registers the trial site information in the clinical trial database 420 in accordance with the above operation, the trial sites α120, β130, and γ140 can register trial subject information and the like after a contract with the sponsor is concluded.

FIG. 17 shows an interface for the registration of trial subject information by the trial site. Numeral 1700 designates a trial subject information registration interface for the registration of information in the subject information table 920. Numeral 1710 designates a trial name selection area for the selection of the name of the trial from the information registered in the trial information table 800. Numeral 1720 designates a trial site sponsor name selection area for the selection of the name of the trial site from the information stored in the trial site information table 900. Numeral 1730 designates a trial subject ID entry area for the entry of the trial subject ID of the trial subject in the trial subject ID area 930. Numeral 1740 designates a sex selection area for the selection of the sex of the trial subject and for the entry of the selected sex in the sex area 932. Numerals 1745, 1750, and 1755 designate a birth of date entry area, a height entry area, and a weight entry area, respectively, for the entry of the birth of date, height, and weight, respectively, of the trial subject in the birth of date area 933, the height area 934, and the weight area 935, respectively. Numeral 1760 designates an agreement acquisition date entry area for the entry of the date of acquisition of an agreement from the trial subject concerning the dose in the agreement acquisition date area 936. Numeral 1765 designates an inspection result file upload area for uploading an electronic file of the results of an inspection conducted prior to the dosing of the trial subject into the inspection result area 937. Numeral 1770 designates a medical image file upload area for uploading a medical imaging data file of the results of the inspection conducted prior to the dosing of the trial subject into the medical imaging data area 1031. Numerals 1775 and 1780 designate a dose beginning date entry area and a dose end date entry area, respectively, for the entry of the date of start and end, respectively, of dose of the trial subject in the dose beginning date area 939 and the dose end date area 940, respectively. Numeral 1785 designates a completed status selection area for the selection of a completed status of the dose of the trial subject from completed, interrupted, and terminated, and for the entry of a selected status in the completed status area 941. Numeral 1790 designates a registration button for the registration of the above information in the clinical trial database 420.

When the trial site α120, β130, or γ140 that has their trial site information registered and of which the sponsor has its contract information registered wishes to register new trial subject information, it needs to enter the trial subject information using the above interface and then depress the registration button 1790. After the information service unit 500 registers the trial subject information in the clinical trial database 420 in accordance with the above operation, the trial sites α120, β130, and γ140 can register visit information and the like.

The electronic file of inspection results is obtained from the laboratory information system 320 or the hospital information system 330. The medical imaging data file is obtained from the medical imaging system 310.

FIG. 18 shows an interface for the registration of visit information and medical imaging information by the trial site. Numeral 1800 designates a visit information and medical imaging information registration interface for the registration of information in the visit information table 1000 and the medical imaging information table 1020. Numeral 1810 designates a trial name selection area for the selection of the name of a trial from the information registered in the information table 800. Numeral 1820 designates a trial site sponsor name selection area for the selection of the name of the trial site from the information registered in the trial site information table 900. Numeral 1830 designates a trial subject ID selection area for the selection of a trial subject ID from the information registered in the trial subject information table 920. Numeral 1840 designates a visit date entry area for the entry of the date of visit by a trial subject corresponding to the selected trial subject ID in the visit date area 1012. Numeral 1845 designates a diagnostic interview result file upload area for uploading an electronic file of the result of a diagnostic interview of the trial subject conducted on the day of visit into the diagnostic interview result area 1013. Numeral 1850 designates an inspection result file upload area for uploading an electronic file of the result of an inspection of the trial subject conducted on the day of visit into the inspection result area 1014. Numeral 1855 designates an adverse event entry area for the entry of adverse event information obtained through a clinical examination of the trial subject conducted on the day of visit in the adverse event area 1016. Numeral 1860 designates a medical image file upload area for uploading a medical imaging data file of the results of an inspection conducted on the trial subject on the day of visit into the medical imaging data area 1031. Numeral 1865 designates a special mention entry area for the entry of a special mention in the medical imaging data file in the special mention area 1032. Numeral 1870 designates a registration button for the registration of the above information in the clinical trial database 420.

When the trial sites α120, β130, and γ140 that have their trial subject information registered wish to register new visit information and medical imaging information, they need to enter visit information and medical imaging information using the above interface, and then depress the registration button 1870. After the information service unit 500 registers the trial subject information in the clinical trial database 420 in accordance with the above operation, the sponsors A 100 and B 110 and the trial sites α120, β130, and γ140 can each conduct a search for medical imaging information and the like.

The electronic file of the diagnostic interview result is obtained from the hospital information system 330. The electronic file of the inspection result is obtained from the laboratory information system 320 or the hospital information system 330. The medical imaging data file is obtained from the medical imaging system 310.

FIG. 19 shows an interface for the entry of retrieval conditions for a search by the sponsors and the trial sites. Numeral 1900 designates a retrieval condition entry interface for the entry of retrieval conditions for acquiring desired information from the clinical trial database 420. Numeral 1910 designates a retrieval key entry area for displaying an interface for retrieval using keywords. Numeral 1920 designates a retrieval image key entry area for displaying an interface for retrieval using medical image. Numeral 1930 designates a retrieval button for executing a search. Numeral 1940 designates a termination button for terminating the retrieval condition entry interface 1900.

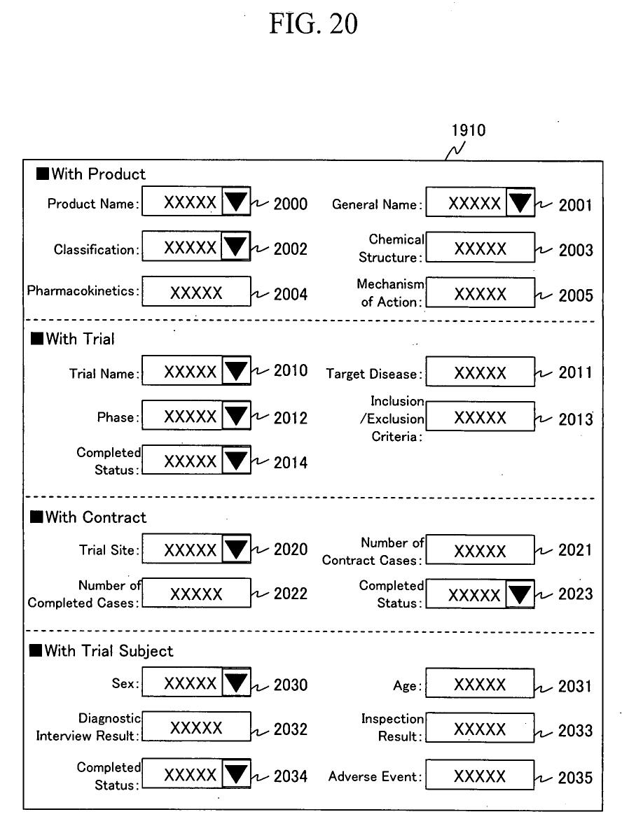

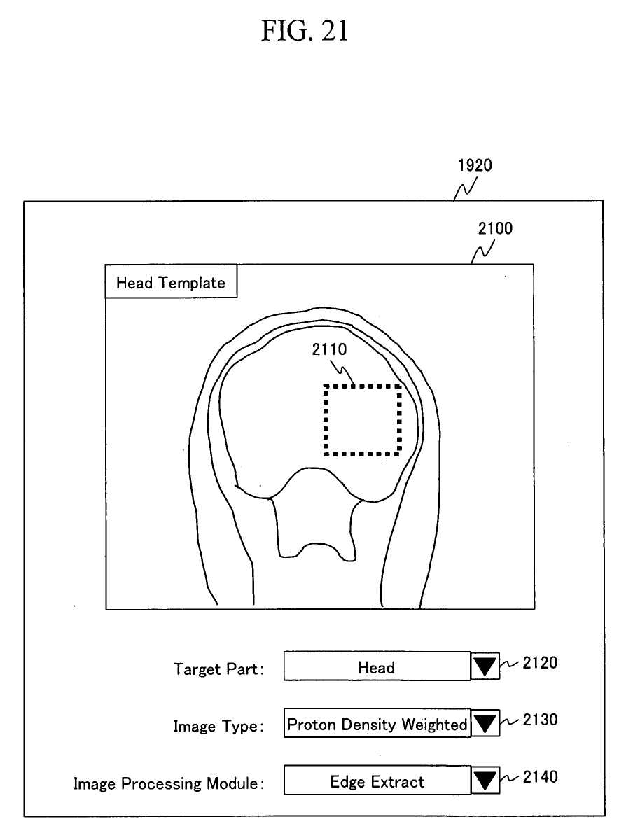

The retrieval key entry area 1910 and the retrieval image key entry area 1920 will be described in detail with reference to FIGS. 20 and 21.

When the sponsors A 100 and B 110 and the trial sites α120, β130, and γ140 wish to conduct a search on past information to investigate the cause of an adverse event or the like, they can do so by entering keys in the retrieval key entry area 1910 and a medical image in the retrieval image key entry area 1920, and then depressing the retrieval button 1930. By thus utilizing a key setting and a medical image condition setting together, it becomes possible to conduct a search for the cause of an adverse event or the like efficiently.

FIG. 20 shows the retrieval key entry area used by the sponsors and trial sites for conducting a search. Numerals 2000, 2001, and 2002 designate a product name selection area, a general name selection area, and a classification selection area, respectively, for the selection of a product name, a general name, and classification, respectively, from the information registered in the product information table 720. Numerals 2003, 2004, and 2005 designate a chemical structure entry area, a pharmacokinetics entry area, and a mechanism of action entry area, respectively, for the entry of the chemical structure, pharmacokinetics, and mechanism of action, respectively, of a product to be retrieved. Numeral 2010 designates a trial name selection area for the selection of the name of a trial from the information registered in the trial information table 800. Numeral 2011 designates a target disease entry area for the entry of the name of a target disease for which the search is to be conducted. Numeral 2012 designates a phase selection area for the selection of the phase of the search from non-clinical, Phase I, Phase II, Phase III, and Phase IV. Numeral 2013 designates an inclusion/exclusion criteria entry area for the entry of information about the selection/exclusion standards of the search. Numeral 2014 designates a trial completed status selection area for the selection of the status at the end of the trial for which the search is to be conducted from completed, interrupted, and terminated. Numeral 2020 designates a trial site selection area for the selection of a trial site name from the information stored in the trial site information table 900. Numerals 2021 and 2022 designate contracted number of cases entry area and a number of completed cases entry area, respectively, for the entry of the contracted number of cases and the number of completed cases, respectively, concerning the search to be conducted. Numeral 2023 designates a contract completed status selection area for the selection of the status at the end of a contract at the trial site from completed, interrupted, and terminated. Numeral 2030 designates a sex selection area for the selection of the sex of the trial subject. Numerals 2031, 2032, and 2033 designate an age entry area, a diagnostic interview result entry area, and an inspection result entry area, respectively, for the entry of the age of the trial subject, a diagnostic interview result, and an inspection result, respectively, for which the search is to be conducted. Numeral 2034 designates a trial subject completed status selection area for the selection of the completed status of the dose of the trial subject from completed, interrupted, and terminated. Numeral 2035 designates an adverse event entry area for the entry of an adverse event for which the search is to be conducted.

When the sponsors A 100 and B 110 and the trial sites α120, β130, and γ140 wish to conduct a search, they enter character information or select an alternative in desired entry areas or selection areas of the retrieval key entry area 1910, whereby retrieval conditions are generated. It is not necessary to fill in all of the above-described entry areas and selection areas.

The “With Product,” “With Trial,” “With Contract,” and “With Trial Subject” shown in the retrieval key entry area 1910 correspond to the hierarchy shown in FIG. 11. Thus, it is possible to limit the retrieval conditions more widely by setting in “With Product” than in “With Trial Subject.” Thus, in accordance with the invention, since the relevant information is stored in a hierarchical structure in accordance with its dependency relationships, a search for the cause of an adverse event or the like can be conducted efficiently.

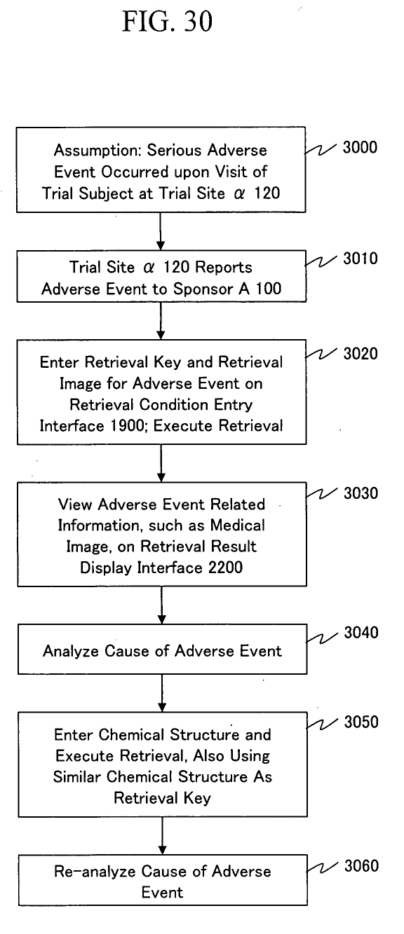

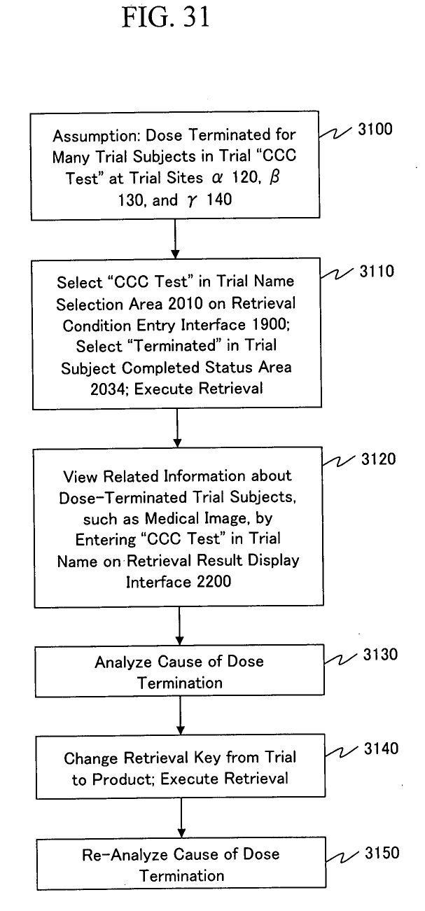

Details of a search will be described with reference to FIGS. 30 and 31.

FIG. 21 shows the retrieval image key entry area to be entered by the sponsors and the trial sites when conducting a search. Numeral 2100 designates a target parts template display area for displaying a template of a part used for the designation of a region when retrieving medical images. Numeral 2110 designates a retrieval object region for designating a region to be retrieved in the target parts template display area 2100. Numeral 2120 designates a target part selection area for the selection of a template of a part displayed in the target parts template display area 2100. Numeral 2130 designates a target image type selection area for the selection of a type of image from the information stored in the medical imaging information table 1020. Numeral 2140 designates an image processing module name selection area for the selection of a desired image processing module from the information stored in the image processing module information table 1040.

When the sponsors A 100 and B 110 and the trial sites α120, β130, and γ140 wish to conduct a search, they first select a desired target part in the target part selection area 2120, and then change the template of a part displayed in the target parts template display area 2100. Then, they change the coordinates and size of the retrieval object region 2110 using an input device, such as the keyboard or mouse attached to the terminal 200 or 300. Finally, they select desired entries in the target image type selection area 2130 and the image processing module name selection area 2140, whereby the medical image search setting is completed.

By thus utilizing the condition setting in the selection areas or the entry areas and the condition setting involving a medical image together, it becomes possible to conduct a search for the cause of an adverse event or the like efficiently.

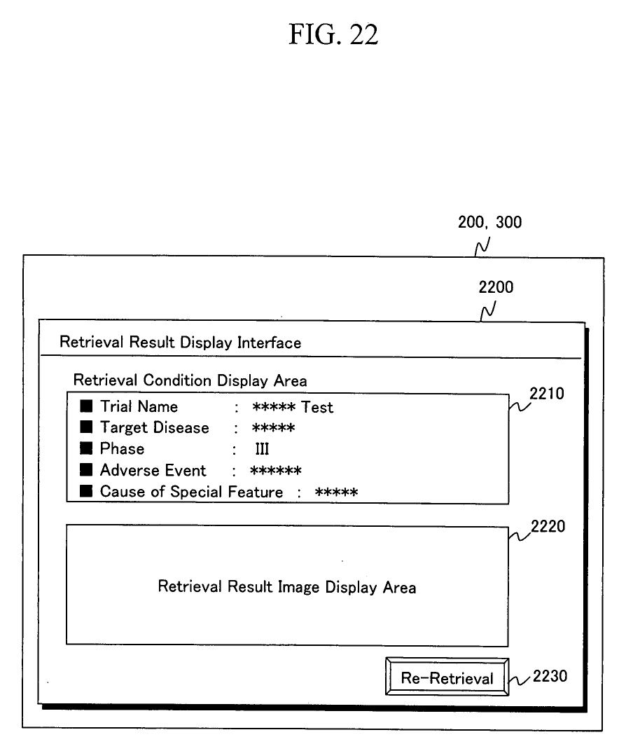

FIG. 22 shows an interface for displaying retrieval results obtained in accordance with the retrieval conditions entered by the sponsors and the trial sites. Numeral 2200 designates a retrieval results display interface for displaying retrieval results obtained in accordance with the retrieval conditions entered in the retrieval condition entry interface 1900. Numeral 2210 designates a retrieval condition display area for displaying the retrieval conditions and information about special/common features extracted from retrieval results. Numeral 2220 designates a retrieval result image display area for displaying medical imaging information acquired on the basis of the retrieval conditions. Numeral 2230 designates a re-retrieval button for conducting a search again.

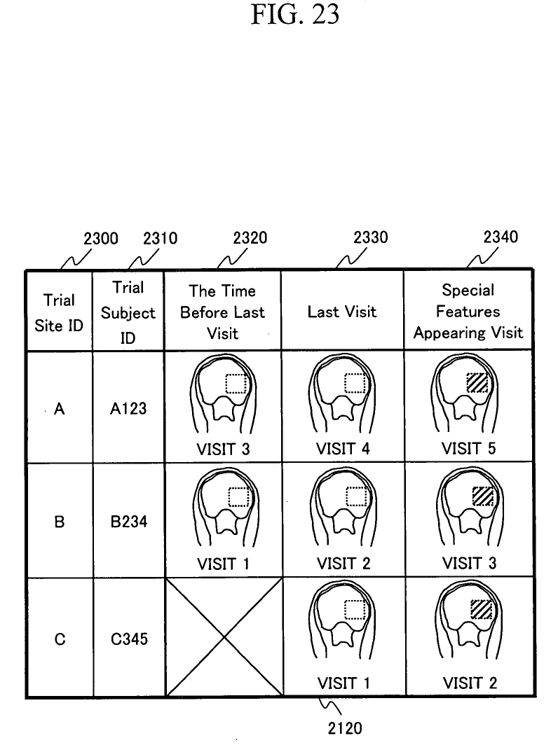

The retrieval result image display area 2220 will be described with reference to FIG. 23 in detail.

The above interface is displayed upon retrieval by the sponsors A 100 and B 110 and the trial sites α120, β130, and γ140. If the content displayed on the interface is not sufficient for a desired analysis, the re-retrieval button 2230 can be depressed to have the retrieval condition entry interface 1900 displayed so as to conduct a search again. By additionally displaying information related to the special and common features extracted from the retrieval results as shown in the present interface, an analysis of the retrieval results by the user can be facilitated.

FIG. 23 shows images displayed in the retrieval result image display area that were obtained on the basis of the retrieval conditions entered by the sponsors and the trial sites. Numeral 2300 designates a trial site ID display area for displaying trial site IDs obtained from the trial site information table 900. Numeral 2310 designates a trial subject ID display area for displaying trial subject IDs obtained from the trial subject information table 920. Numerals 2320, 2330, and 2340 designate a time before last visit result display area, a last visit result display area, and a special features appearing visit result display area, respectively, for displaying medical imaging data from visits with respect to a reference visit when a special feature developed; namely, a time-before-last visit, a last visit, and the reference visit, the medical imaging data being obtained by processing acquired medical imaging data for each trial subject.

After a search is conducted by the sponsors A 100 and B 110 and the trial sites α120, β130, and γ140, the medical imaging data in the retrieval results is displayed in the form of a table showing trial site IDs and trial subject IDs on the vertical axis and visits on the horizontal axis. Along the horizontal axis, past images are displayed with reference to medical images having different, i.e., special, features, are displayed.

By thus displaying the medical imaging data according to the trial site and the trial subject, and also displaying past information with reference to the visit where a problem occurred, as shown in the present interface, the user's analysis of retrieval results can be facilitated.

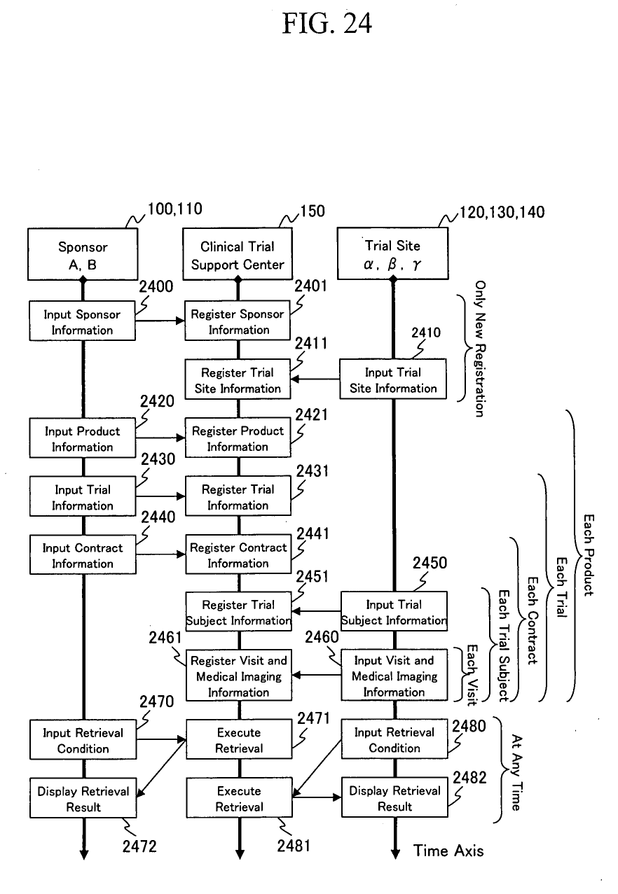

FIG. 24 shows a diagram of operation events performed with respect to the clinical trial support center along the time axis. First, the sponsors A 100 and B 110 enter sponsor information using the sponsor information registration interface 1200 (step 2400). The sponsor information is registered by the clinical trial support center 150 of the invention in the clinical trial database 420 (step 2411). The trial sites α 120, β 130, and γ 140 also enter trial site information using the trial site information registration interface 1600 (step 2410). The trial site information is registered by the clinical trial support center 150 in the clinical trial database 420 (step 2411). Steps 2400 and 2401 only need to be performed upon newly registering sponsor information; steps 2410 and 2411 only need to be performed upon newly registering a trial site.

When the sponsor A 100 or B 110 wishes to develop new a drug, it enters relevant product information using the product information registration interface 1300 on a product by product basis (step 2420). The product information is then resisted by the clinical trial support center 150 in the clinical trial database 420 (step 2421). When the sponsor A 100 or B 110 wishes to conduct a trial on the product for a particular purpose, it enters relevant trial information using the trial information registration interface 1400 on a trial by trial basis (step 2430). The trial information is then registered by the clinical trial support center 150 in the clinical trial database 420 (step 2431).

In order to conduct the trial, it is necessary to conclude a contract between the sponsor A 100 or B 110 and the trial site α 120, β 130, or γ 140. After a contract is concluded, the sponsors A 100 or B 110 enters the contract information using the contract information registration interface 1500 on a trial site by trial site basis (step 2440) and register the contract information in the clinical trial database 420 (step 2441).

The trial site α 120, β 130, or γ 140 that has concluded the contract obtain trial subjects enters relevant trial subject information using the trial subject information registration interface 1700 on a trial subject by trial subject basis (step 2450), and register the trial subject information in the clinical trial database 420 (step 2451).

After dosing of a trial drug is initiated on the trial subjects, the trial site α 120, β 130, or γ 140 enter visit information and medical imaging information using the visit information and medical imaging information registration interface 1800 on a visit by visit basis (step 2460), and register the visit information and the medical imaging information in the clinical trial database 420 (step 2461).

When it is desired to analyze past information in the event of an adverse event or the like during the processes of entry and/or registration of the aforementioned various information, the sponsor A 100 or B 110 and the trial site α 120, β 130, or γ 140 can both enter retrieval conditions using the retrieval condition entry interface 1900 as needed (step 2470, 2480), so as to have a search conducted at the clinical trial support center 150 (step 2471, 2481) and have retrieval results displayed (step 2472, 2482), so that the cause of the problem can be analyzed.

In accordance with such operation events, the information acquired from the sponsors and the trial sites is centrally managed at the clinical trial support center 150, where such information is stored in a hierarchical structure in accordance with its dependency relationships. In this way, a search for the cause of an adverse event or the like can be conducted efficiently.

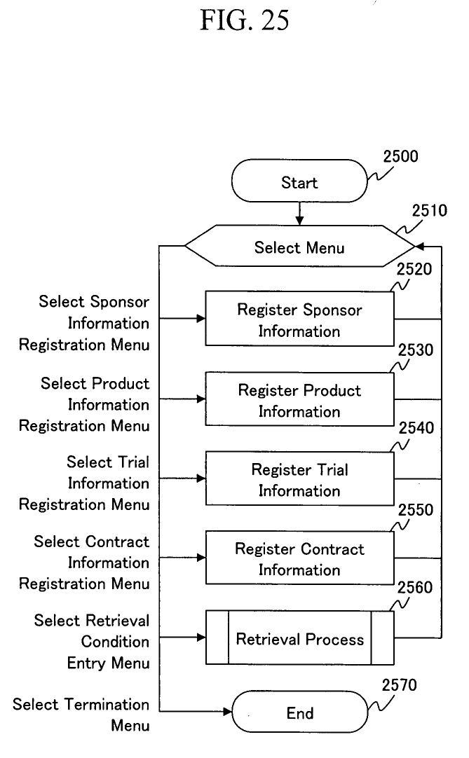

FIG. 25 shows a flowchart of the procedure at the sponsor's end in the clinical trial support system. As the sponsor A 100 or B 110 accesses the clinical trial support system 440 from the terminal 200 via the Internet 170 (step 2500), the information service unit 500 presents menu selections (step 2510).

If the sponsor A 100 or B 110 selects a sponsor information registration menu, the information service unit 500 presents the sponsor information registration interface 1200, and prompts entry of sponsor information by the sponsor A 100 or B 110. As the sponsor A 100 or B 110 enters the relevant information and depress the registration button 1260, the information service unit 500 registers the thus entered information in the sponsor information table 700 (step 2520); the routine then returns to step 2510.

If the sponsor A 100 or B 110 selects a product information registration menu in step 2510, the information service unit 500 presents the product information registration interface 1300, and prompts entry of product information by the sponsor A 100 or B 110. As the sponsor A 100 or B 110 enters the relevant information and depress the registration button 1380, the information service unit 500 registers the thus entered information in the product information table 720 (step 2530); the routine then returns to step 2510.

If the sponsors A 100 and B 110 select a trial information registration menu in step 2510, the information service unit 500 presents the trial information registration interface 1400 and prompts entry of trial information by the sponsor A 100 or B 110. As the sponsor A 100 or B 110 enters the relevant information and depress the registration button 1480, the information service unit 500 registers the thus entered information in the trial information table 800 (step 2540); the routine then returns to step 2510.

If the sponsor A 100 or B 110 selects a contract information registration menu in step 2510, the information service unit 500 presents the contract information registration interface 1500 and prompts entry of contract information by the sponsor A 100 or B 110. As the sponsor A 100 or B 110 enters the relevant information and depress the registration button 1570, the information service unit 500 registers the thus entered information in the contract information table 830 (step 2550); the routine then returns to step 2510.

If the sponsor A 100 or B 110 selects a retrieval condition entry menu in step 2510, the information service unit 500 carries out the retrieval process (step 2560); the routine then returns to step 2510.

If the sponsor A 100 or B 110 selects a termination menu in step 2510, the information service unit 500 brings the routine to an end (step 2570).

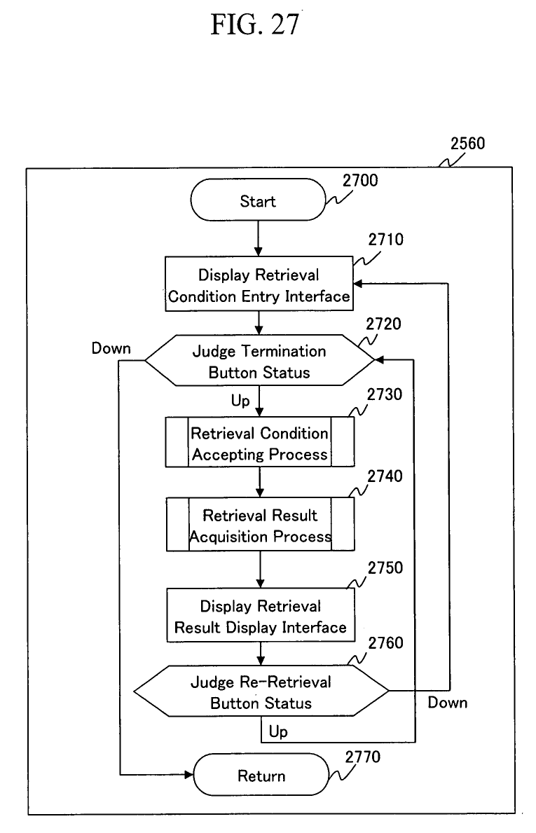

The retrieval process 2560 will be described with reference to FIGS. 27, 28, and 29 in detail.

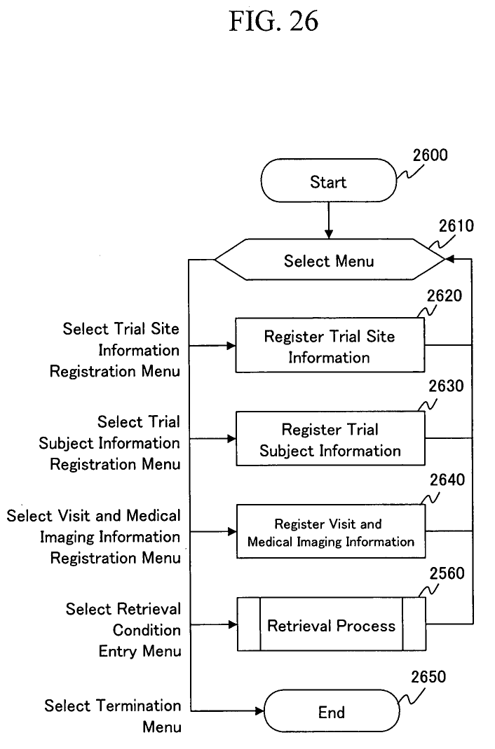

FIG. 26 shows a flowchart of the procedure at the trial site's end in the clinical trial support system. As the trial site α 120, β 130, or γ 140 access the clinical trial support system 440 from the terminal 300 via the Internet 170 (step 2600), menu selections are presented by the information service unit 500 (step 2610).

In step 2610, if the trial sites α 120, β 130, and γ 140 select a trial site information registration menu, the information service unit 500 presents the trial site information registration interface 1600 and prompts entry of trial site information by the trial site α 120, β 130, or γ 140. The trial site α 120, β 130, or γ 140 enters the relevant information and depress the registration button 1670, whereupon the information service unit 500 registers the thus entered information in the trial site information table 900 (step 2620); the routine then returns to step 2610.

If the trial site α 120, β 130, or γ 140 selects a trial subject information registration menu in step 2610, the information service unit 500 presents the trial subject information registration interface 1700 and prompts entry of trial subject information by the trial site α 120, β 130, or γ 140. As the trial site α 120, β 130, or γ 140 enters the relevant information and depress the registration button 1790, the information service unit 500 registers the entered information in the trial subject information table 920 (step 2630); the routine then returns to step 2610.

If the trial site α 120, β 130, or γ 140 selects a visit information and medical imaging information registration menu in step 2610, the information service unit 500 presents the visit information and medical imaging information registration interface 1800 and prompts entry of visit information and medical imaging information by the trial site α 120, β 130, or γ 140. As the trial site α 120, β 130, or γ 140 enters the relevant information and depress the registration button 1870, the information service unit 500 registers the entered information in the visit information table 1000 and the medical imaging information table 1020 (step 2640); the routine then returns to step 2610.

If the trial site α 120, β 130, or γ 140 selects a retrieval condition entry menu in step 2610, the information service unit 500 carries out a retrieval process (step 2560); the routine then returns to step 2610. If the trial site α 120, β 130, or γ 140 selects an termination menu in step 2610, the information service unit 500 brings the routine to an end (step 2650).

The retrieval process 2560 will be described with reference to FIGS. 27, 28, and 29 in detail.

FIG. 27 shows a flowchart of the procedure of the retrieval process in detail. At the start of the retrieval process 2560 (step 2700), the information service unit 500 presents the retrieval condition entry interface 1900 and prompts entry of retrieval conditions by the sponsor A 100 or B 110 or the trial sites α 120, β 130, and γ 140 (step 2710).

It is then determined whether or not the sponsor A 100 or B 110 or the trial site α 120, β 130, or γ 140 depressed the termination button 1940 (step 2720). If they did, the retrieval process is terminated (step 2770). If it is determined in step 2720 that the termination button 2940 is not depressed, the information service unit 500 carries out a retrieval condition accepting process (step 2730), followed by a retrieval results acquisition process (step 2740).

Thereafter, the information service unit 500 causes the retrieval results generated in step 2740 and information about special/common features extracted from the retrieval results to be displayed on the retrieval results display interface 2200. It is then determined whether or not the sponsor A 100 or B 110 or the trial site α 120, β 130, or γ 140 depressed the re-retrieval button 2230 (step 2760); if they did, the routine returns to step 2710. If it is determined in step 2760 that the re-retrieval button 2230 is not depressed, the routine returns to step 2720.

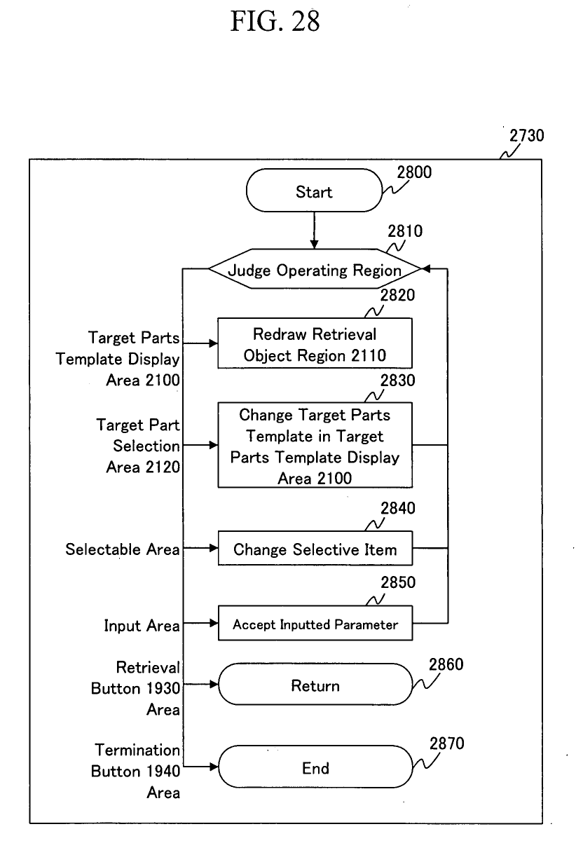

The retrieval condition accepting process 2730 will be described with reference to FIG. 28 in detail; the retrieval results acquisition process 2740 will be described with reference to FIG. 29 in detail.

FIG. 28 shows a flowchart of the procedure of the retrieval condition accepting process in detail. At the start of the retrieval condition accepting process 2730 (step 2800), the information service unit 500 determines the area in which the trial sponsor A 100 or 110 or the trial site α 120, β 130, or 140 performed an entry operation (step 2810). If the area is the target parts template display area 2100 in step 2810, the retrieval object region 2110 is redrawn in accordance with the entry operation (step 2820), and the routine returns to step 2810. If the area in step 2810 is the target part selection area 2120, the template displayed in the target parts template display area 2100 is changed in accordance with the selected target part name (step 2830), and then the routine returns to step 2810.

If the area in step 2810 is a selection area in the retrieval key entry area 1910 or the image processing module selection area 2140, each selective item is changed in accordance with the entry operation (step 2840), and then the routine returns to step 2810. If the area in step 2810 is an entry area in the retrieval key entry area 1910, the entered value is set in each entry area (step 2850), and then the routine returns to step 2810. If the area in step 2810 is the retrieval button 1930, the retrieval condition accepting process is terminated while the entered and selected values are retained (step 2860). If the area in step 2810 is the termination button 1940, the retrieval condition entry interface 1900 is closed and the retrieval process 2560 is terminated (step 2870).

FIG. 29 shows a flowchart of the procedure of the retrieval results acquisition process in detail. Upon implementing the retrieval results acquisition process 2740 (step 2900), the retrieval condition interpretation unit 510 interprets the values entered or selected as retrieval conditions on the retrieval condition entry interface 1900 (step 2910). In step 2910, the chemical structure entered in the chemical structure entry area 2003 is delivered to the similar chemical structure identified unit 520, followed by step 2915. In step 2910, the values entered or selected in the retrieval key entry area 1910 are modified into retrieval statements, such as SQL (Structured Query Language), with which the database control unit 430 can control the clinical trial database 420, and such the statements are delivered to the retrieval processing unit 530, followed by a standby status (step 2920). In step 2910, the values of the target part, image type, retrieval object region, and image processing module name are delivered to the image processing module execution unit 540, followed by a standby status (step 2935).

Then, the similar chemical structure identified unit 520 searches the medical public database 160, using the chemical structure received from step 2910 as a retrieval key, for similar chemical structures (step 2915). Upon delivery of the thus acquired similar chemical structures to the retrieval processing unit 530, the standby status in step 2920 is lifted, followed by step 2925. An example of the medical public database 160 is “Hakkutsu Yaku-yaku Daijiten: Dictionary of Medicines (http://medicine.cug.net/). If there is no such medical public database 160 that outputs a similar chemical structure in response to the input of a chemical structure, retrieval statements may be generated on the basis of information about a product's general name, classification, pharmacokinetics, and mechanism of action, in addition to the information about its chemical structure, and then the clinical trial database 420 may be searched for a similar chemical structure based on the registered information.

The retrieval processing unit 530 composes the search formula received from step 2910 with the similar chemical structure received from step 2915 to generate retrieval statements, such as SQL (step 2925), and then conducts a search on the clinical trial database 420 via the database control unit 430 (step 2930). The medical imaging data obtained as a retrieval result in step 2930 is delivered from the retrieval processing unit 530 to the image processing module execution unit 540, whereupon the standby status in step 2935 is lifted, followed by step 2940. The medical imaging data is also delivered to the information service unit 500, followed by a standby status (step 2955).

In the image processing module execution unit 540, the values of the target part, image type, retrieval object region, and image processing module name received from step 2910 and the medical imaging data received from step 2930 are used as inputs to carry out image processing by means of an image processing module obtained from the image processing module information table 1040 (step 2940). The result of image processing in step 2940 is delivered from the image processing module execution unit 540 to the special/common feature detection unit 550, where features specifically different from others (special features) and common features are extracted from the image processing result (step 2945).

For the detection of such special and common features, template matching is available; particularly, the sequential similarity detection algorithm (SSDA) is effective. By performing such detection algorithm, features specifically different from other image processing results can be obtained as special features while substantially identical features are obtained as common features. For more details about the SSDA, reference may be made to “Handbook of Image Analysis: Revised Edition”, M. Takagi and H. Shimoda, University of Tokyo Press.

The information about the special/common features extracted in step 2945 is delivered from the special/common feature detection unit 550 to the special/common feature related information retrieval unit 560, which, using the special/common features as retrieval keys, queries the medical public database 160 and acquires information relating to the special/common features (step 2950).

The medical public database 160 preferably is in a web site that simultaneously publishes clinical data and radiogram interpretation reports describing observations about the data. If no web site satisfying such condition exists, retrieval statements may be generated on the basis of the special/common features and the clinical trial database 420 may be searched so as to acquire related information from the information that is already registered.

Upon delivery of the special/common features related information acquired in step 2950 to the information service unit 500, the standby status in step 2955 is lifted and the retrieval results acquisition process 2740 ends (step 2960).

By performing such process, the clinical trial support system 440 can retrieve not just the chemical structure entered as a retrieval condition but also chemical structures similar thereto; thus, information that could have been overlooked by the user can be acquired.

Furthermore, it becomes possible to not just acquire the medical imaging information as retrieval results but also information related to special and common features detected in such medical images. Since not just the medical imaging information but also related information about their special and common features can be displayed together, the user's analysis of the retrieval results can be facilitated.

FIG. 30 shows an example of how the clinical trial system is used. It is assumed (step 3000) that a serious adverse event has occurred during the visit of a trial subject of a trial at the site α120. In case of such event, the trial site α120 has the duty to report the adverse event to the sponsor A 100, who commissioned the trial (step 3010). In response to such report, the sponsor A 100 needs to analyze the adverse event immediately. If the clinical trial system of the invention is in place, the investigation of the cause of the adverse event can be facilitated by performing the following operation.

First, on the retrieval condition entry interface 1900, retrieval keys and a retrieval image associated with the adverse event are entered and a search is conducted (step 3020). As a result, it becomes possible to view, as information about the adverse event, special and common features related information and also relevant medical images in a table according to each trial site and each trial subject, with reference to the visit where the special features developed, on the retrieval results display interface 2200 (step 3030). Thus, the related information can be viewed at once, making it easier to analyze the cause of the adverse event (step 3040).

If the investigation of the cause of the adverse event was not sufficient in step 3040, the chemical structure of a product associated with the trial can be entered to conduct a search more widely, including similar chemical structures (step 3050). In this way, the cause of the adverse event can be more widely analyzed (step 3060).

FIG. 31 shows another example of the use of the clinical trial system. A case is assumed in which the dose of trial subjects for a trial named “CCC Test” has been terminated for one subject after another (step 3100). Under such circumstances, if the sponsor A 100 that commissioned the trial wishes to investigate the cause of the terminations of the dose, where the clinical trial system is in place, the following operation can be performed.

First, on the retrieval condition entry interface 1900, “CCC Test” is selected in the trial name selection area 2010 and “Terminated” is selected in the trial subject completed status selection area 2034, and then a search is conducted (step 3110). It then becomes possible to view, on the retrieval results display interface 2200, the medical imaging information about all of the trial subjects whose trial name was “CCC Test” and whose dose has been terminated, together with their related information, in a table according to each trial site and each trial subject and with reference to the visit where special features developed (step 3120). In this way, the relevant information can be viewed at once, thereby facilitating the analysis of the cause of the dose terminations (step 3130).

If the analysis of the cause of the dose terminations was insufficient in step 3130, a search can be conducted again using a retrieval key associated with a product instead of a trial (step 3140). As a result, it becomes possible to view wider-range information, so that the cause of the dose terminations can be analyzed more widely (step 3150).

While it has been described above how inspection data and the like with regard to nonclinical studies, clinical studird, or clinical trials is managed, the present invention can also be applied to a CAD (computer aided diagnosis) system having a medical image archiving and communication system called “PACS” (picture archiving communication system) as a back-end and the clinical trial support system of the invention as a front-end.

What is claimed is:

1. A clinical trial support system using medical imaging information, comprising:
a clinical trial database in which information about drugs, information about trials, information about trial subjects, and visit information about the visit date of a trial subject who made a visit, inspection results, medical images, and an adverse event are stored in association with one another;
retrieval condition entry means having a retrieval key entry area and a retrieval image key entry area for entering a condition for a search;
retrieval means for searching the clinical trial database so as to extract visit information corresponding to a retrieval key entered via the retrieval condition entry means and a medical image accompanying the visit information;
means for detecting a special feature and a common feature from a plurality of medical images extracted by the retrieval means; and
display means for displaying a retrieval result.

2. The clinical trial support system using medical imaging information according to claim 1, wherein the plurality of medical images are displayed on the display means two-dimensionally, wherein one axis shows the trial subjects and the other axis shows past visits with reference to a visit during which a special feature developed.

3. The clinical trial support system using medical imaging information according to claim 1, wherein the retrieval image key entry area includes: a target parts template display area; a target part selection portion for selecting a template to be displayed in the target parts template display area; and means for selecting a region of the template displayed in the target parts template display area that is desired to be retrieved.

4. The clinical trial support system using medical imaging information according to claim 1, wherein the information about the trial includes information about the completed status of the trial as a whole, and wherein the retrieval key entry area includes an area for designating the completed status of the trial as a whole.

5. The clinical trial support system using medical imaging information according to claim 1, wherein the information about the trial subject includes information indicating a completed status of dose of the trial subject, and wherein the retrieval key entry area includes an area for designating a dose completed status.

6. The clinical trial support system using medical imaging information according to claim 1, further comprising a similar chemical structure retrieval means for retrieving, upon entry of a chemical structure in the retrieval key entry area, a chemical structure similar to the entered chemical structure from an external database, wherein the retrieval means searches the clinical trial database using the chemical structure retrieved by the similar chemical structure retrieval means as an equivalent to the chemical structure entered in the retrieval key entry area.

7. The clinical trial support system using medical imaging information according to claim 1, wherein, in the retrieval key entry area of the retrieval condition entry means, retrieval keys are arranged in a hierarchical structure reflecting the dependency relationships of the information stored in the clinical trial database.

8. The clinical trial support system using medical imaging information according to claim 1, wherein a medical image extracted by the retrieval means is displayed by the display means according to each facility, each trial subject, and in order of the date of acquisition.
